(19) United States
(12) Patent Application Publication
(10) Pub. No.: US 2007/0038539 A1
(43) Pub. Date: Feb. 15, 2007

(54) Methods for financing properties using structured transactions

(76) Inventors: Richard A. Gross, Washington, DC (US); Sandra L. Spalletta, Rockville, MD (US)

Correspondence Address: NIXON & VANDERHYE, PC, 901 NORTH GLEBE ROAD, 11TH FLOOR, ARLINGTON, VA, 22203, US

(21) Appl. No.: 11/529,546

(22) Filed: Sep. 29, 2006

Related U.S. Application Data
(63) Continuation-in-part of application No. 10/417,338, filed on Apr. 17, 2003.
(60) Provisional application No. 60/373,326, filed on Apr. 18, 2002.

(51) Int. Cl. G06Q 40/00

(52) U.S. Cl. 705/35

(57) ABSTRACT

A method of financing real estate in a manner that provides advantageous results for all parties to the transaction is provided. A novel method includes using an accrual to achieve advantageous accounting treatment for the parties to the transaction. The transaction may be structured to enable the lessee to achieve operating lease treatment, thereby avoided an adverse impact on the lessee's balance sheet. The transaction may also be structured to achieve leverage lease accounting treatment for the lessor. Certain exemplary embodiments accomplish these and other advantages by requiring the separation of land and building ownership, though certain other exemplary embodiments bypass this requirement. Additionally, certain exemplary embodiments confer these and other advantages to corporations, owners of buildings for rent, and/or developers.

### CROSS-REFERENCES TO RELATED APPLICATIONS

This application is a continuation-in-part of U.S. application Ser. No. 10/417,338 entitled “Methods for Financing Properties Using Structured Transactions,” filed Apr. 17, 2003, which claims the benefit of U.S. Provisional Application Ser. No. 60/373,326 entitled “Method and System for Funding Properties,” filed Apr. 18, 2002, each incorporated herein by reference in its entirety.

### FIELD OF THE INVENTION

The exemplary embodiments herein relate to a new and improved method for financing properties, and, more particularly, to an improved property financing method that enables property owners and investors to achieve advantageous results through the financing of new construction, renovation of existing structures and transfer of existing structures, regardless of whether the parties to the transaction are tax-paying entities or tax-indifferent parties. The exemplary embodiments provide a novel method of using an accrual to achieve advantageous accounting treatment for the parties to the transaction. The transaction may be structured to enable the lessee to achieve operating lease treatment, thereby avoiding an adverse impact on the lessee's balance sheet and enhancing its credit ratings. The transaction may also be structured to achieve leverage lease accounting treatment for the lessor, thereby providing favorable operating results on its reported financial statements, positive cash flow throughout the life of the investment, and significant tax benefits. Furthermore, according to certain exemplary embodiments, a party to the transaction may realize the advantages of the methods disclosed herein alone, or the advantages may be conferred to various combinations of parties to the transaction.

### BACKGROUND AND SUMMARY OF THE INVENTION

One of the instant inventors, Richard Gross, developed and used a unique real estate financing model in transactions he structured for his clients. The model was developed for tax-indifferent parties who wanted to construct or rehabilitate buildings on land they owned but lacked the necessary funding to do so. Mr. Gross proposed that each of these parties lease its land to private investors which would, in turn, either construct a new building, or rehabilitate an existing building, on the leased ground. The investors would lease the ground pursuant to a long-term ground lease under which payment of the ground rent could be deferred and accrued, together with compounding interest, during the initial twenty years of the ground lease term. The tax-indifferent party would record the deferred rent and accrued interest as income during this period. The investors, as accrual-based taxpayers, would record and deduct the ground rent and the associated interest as a current expense even though the actual payment would not occur at that time. The tax-indifferent party would then lease the newly constructed or rehabilitated building from the investors. After twenty years the investors would either pay any deferred ground rent plus accrued interest thereon in cash or relinquish the property in which case the ground lease would terminate, leaving the tax-indifferent party owning both the ground and building.

The consummated transactions generally involved the rehabilitation of buildings for which an historic rehabilitation tax credit was available under the Internal Revenue Code. The investors, having assumed all benefits and burdens of ownership of the building throughout its useful life pursuant to the ground lease, would be treated as the owner of the building for Federal income tax purposes and would be entitled to this credit as well as annual tax deductions for (a) depreciation, (b) interest payments, and (c) the accrued ground rent and interest on the accruals. The transactions typically provided the investors with both a cash and tax return but required them to recognize substantial losses on their financial statements prepared in accordance with generally accepted accounting principles (“GAAP”) as a result of these deductible costs. Because of these losses, the transactions were of limited use to most investors. Even though investors could receive an overall return of approximately 18% to 25% on their investments as a result of the historic rehabilitation tax credit, the impact on the investors' public financial statements severely curtailed the usefulness and attractiveness of the transactions.

Consequently, the original model had several significant drawbacks. First, the transaction was limited to the construction of new buildings or the renovation of existing buildings. It was never applied to existing structures that were not in need of renovation. Second, because of the grave impact to the investors' financial statements, the majority of investors were not interested in the transaction unless they could receive a rehabilitation tax credit sufficient to achieve returns which would offset this harmful impact on their income statements. Third, property owners were reluctant to use the structure if they had to reflect the real property and its associated liabilities on their balance sheets under GAAP as this negatively affected their credit ratings. Fourth, the transaction was applicable only to structures currently owned by or to be constructed for a tax-indifferent party. Combined, these four impediments severely limited the usefulness and applicability of the original transaction model.

Thus, a need existed for a new and improved real estate financing model that overcame the disadvantages of the prior model. The exemplary embodiments herein provide techniques for overcoming these and other disadvantages.

The instant inventors have added substantial innovations to the prior model which have reduced its major drawbacks and facilitated a broader application by property owners and investors. The innovations enable the model to be used for the financing of existing buildings not in need of renovation, thereby affording initial cash payments to property owners. In accordance with an aspect of the invention, leverage lease treatment has been made available for investors thus avoiding GAAP losses on their income statements. In addition, operating lease treatment has been made available for property owners thus removing the real estate and its associated liabilities from their balance sheets and enhancing their credit ratings. The model has also been made applicable to properties having low land values. Finally, the model was adapted for both tax-paying property owners as well as tax-indifferent ones.

The first innovation involves applying the model to the sale of existing structures that do not need renovation. Cash that would have been required to renovate a building, or construct a new building, is therefore available to be paid to the original property owner. While a sale-leaseback is not a new concept, the model uses accruing ground rent in a novel manner to achieve advantageous results for the parties to the sale-leaseback transaction.

Next, the model has been redesigned to reduce the negative financial statement impact to the investors under GAAP while still providing them positive cash flow, attractive returns, and significant tax benefits. The reduction of the transaction's negative impact on the investors' financial statements is achieved through the application of leverage lease accounting under the accounting rule set forth in Financial Accounting Standards Board Rule 13 (“FASB 13”). Generally, FASB 13 requires identical classification of a lease as either a capital lease or an operating lease in the financial statements of both parties to the lease. Property owners will often not participate in a sale leaseback without the resulting leaseback being accounted for as an operating lease in their financial statements. On the other hand, if the building leaseback is treated as an operating lease by the investors who acquire the building, they will be required to show losses on their financial statements due to the deductions they are taking as discussed above. If the lease were classified as a capital lease on the investors' financial statements, then they could apply leverage lease accounting to reduce the negative impact of these deductions on their financial statements.

FASB 13 sets forth four criteria to a lease transaction to determine whether the lease should be classified as an operating lease or as a capital lease; the same four criteria must be applied by both the lessee and the lessor to the lease. Under the first three criteria, the lease is a capital lease to both parties if (a) the lease transfers ownership of the property to the lessee by the end of the lease, (b) the lease contains a bargain purchase option, or (c) the lease term is equal to 75% or more of the estimated economic life of the property. Under the fourth criterion, if the present value at the beginning of the lease term of the minimum lease payments to be paid by the lessee exceeds 90% of the fair market value (“FMV”) of the property at the inception of the lease, then the lease is a capital lease. It is only the fourth criterion that provides some flexibility such that the lease may properly be considered as an operating lease by the lessee and a capital lease by the lessor.

The inventors have creatively crafted a unique approach to this problem. In accordance with one embodiment of the invention (the “PFG model”), the original owner of the land and building is the lessor of the land but the lessee of the building pursuant to its leaseback. By “netting” the payment stream of the land rent against that of the building rent, the minimum lease payments for the original land owner/building lessee are decreased. An example best illustrates this scenario. Assume the original tax-indifferent owner of real estate valued in total at $10 million sold the building to investors while leasing the underlying land to the same investors at an annual rate of $100,000, though deferred for 20 years. Further assume that investors leased the building back to the tax-indifferent party at an annual rate of $1 million. Since the $1 million lease rate payable by the tax-indifferent party to the investors constitutes rent for the building and a sublease of the land, and the underlying land is being leased to the investors for $100,000, the minimum lease payment by the tax indifferent party is $900,000 for purposes of the FASB 13 determination. This payment stream would be compared with the FMV of the real property, both land and building, to determine whether the 90% test were met, using the tax indifferent party's relatively low cost of funds.

This netting effect has a significant effect on lease classification under FASB 13. If the present value of the entire $1,000,000 rent payment stream was considered and exceeded 90% of the FMV of the real property, then the lessee would have to capitalize the asset. Thus, the tax-indifferent party would be required to reflect on its balance sheet ownership of the real property with a value of $10 million. However, under the PFG model, the “net” of the ground rent and the building rent is used in determining the FASB 13 calculation. After netting, the present value does not exceed 90% of the FMV of the property and, as a result, the tax-indifferent party is able to obtain operating lease classification.

As an alternative to the netting approach, and because the FASB has published additional guidance on accounting for lease transactions, the use of a Variable Interest Entity (“VIE”) is a preferred method to achieve leveraged lease accounting treatment for the Lessor. Details on this approach are set forth below.

Although the above description states that the land should be sold and leased-back, the instant invention is not so limited. As will become apparent from the detailed description given below, certain exemplary embodiments provide techniques in which the land and the building on the land may be owned by the same person or entity. This arrangement may be advantageous in certain cases, such as, for example, when fewer parties are involved, when it is difficult to align many stakeholders' interests, when there may be unfavorable tax or economic consequences associated with using the ground lease structure, etc. Thus, a beneficial aspect of these embodiments relates to allowing for an identity of at least certain parties, for example, potentially simplifying the overall process.

In brief, in such embodiments, the property owner may lease both the land and the building to a creditworthy tenant and may obtain non-recourse tiered debt financing secured by the land and building. The subordinate debt would be a zero-coupon debt with accruing and compounding interest similar to the accruing and compounding rent and interest due under the ground lease structure. In a first variant of this technique, all or part of the subordinate debt may be insured under residual value insurance to insure that the property value will be sufficient to provide a fixed yield to the insured subordinate lender, thereby also reducing the interest rate that must be paid on that portion of the subordinate debt covered by the residual value insurance. Thus, such embodiments provide the further advantage that the accrual may grow higher, as it will be measured against the estimated future value of both the land and building, rather than just the building, for purposes of determining the federal income tax consequences of the lease transaction.

In a second variant of this technique, the property owner may also seek equity investment itself or into an entity that it may establish to own the property and thus benefit from tax deductions available. Such deductions may include, for example, deductions available with respect to property depreciation, interest deductions for interest paid currently under the senior debt and for interest accruing under the subordinate debt, and other deductions available with respect to property ownership. Thus, tax benefits may be obtained for the lessor or the lessee regardless of the accounting treatment.

In accordance with another embodiment of the invention (the “CPFG model”), the lessee is a tax-paying entity in contrast to the lessee in a PFG transaction. Consequently, the lessee's cost of funds is generally higher. Thus, when applying the fourth prong of FASB 13 to the transaction, a higher implicit interest rate is utilized. As a result, the lessee in a CPFG transaction still passes the fourth prong and can treat the lease as an operating lease.

The investors in the above examples would have a minimum lease payment of $1,000,000, the rent received for the leaseback of the building together with sub-leasing of the land (leaseback of the land in a CPFG transaction). Since the investors acquired only the building, the $1,000,000 together with residual value inuring to the benefit of investors is measured against the value of the building only to determine their implicit rate in the transaction. This results in a present value rent calculation exceeding the 90% test of FASB 13, thereby resulting in capital lease classification in both models. Alternative embodiments are provided in which either a bargain purchase option is utilized or a variable interest entity (“VIE”) is established to achieve the desired accounting treatment for the lessor (i.e., capital lease treatment on the land). Once the transaction is considered a capital lease, the investors are able to utilize leverage lease treatment. The result of the leverage lease treatment is that, under GAAP, the investors no longer need to declare losses on their financial statements as a result of the transaction because the gain recognized by the investors in the twentieth year would be allocated over the initial years of the lease term, thereby offsetting the effects of the deductions taken during this period. The investors then have both positive income on their financial statements and positive cash flow throughout the term of the building leaseback, as well as significant tax benefits from the transaction. As a result of the impact directly attributable to leverage lease treatment, the transactions no longer require as high a return as that provided from transactions utilizing tax credits under the original model. Thus, the PFG/CPFG transactions are no longer dependent on the historic rehabilitation tax credit and many more investors can advantageously take part in them.

The instant inventors have recognized that some properties do not have sufficient land value to support the necessary accrual to provide the benefits described above. However, in accordance with certain exemplary embodiments, in instances, where additional cash may be needed for construction/renovation and in other situations, the deferral feature of the model has been expanded to incorporate deferrals of amounts due with respect to other tangible and/or intangible assets. For example, the land owner or an independent lender may lend money to the investors and such debt may be repaid on a deferral zero-coupon basis in the same manner, and with the same consequences, as deferred ground rent. Thus, the certain exemplary embodiments can be used even when the target property does not have sufficient land value for accrual purposes, or when other financial or tax considerations require, by deferring amounts due with respect to other tangible and/or intangible assets.

Another major innovation in the model has made it more attractive to property owners. As noted above, all of the prior applications required that the original owner of the real property be a tax-indifferent party. However, the CPFG model modifies the PFG model so that taxpaying entities such as corporations can sell their real property and lease it back at below market rental rates. First, in accordance with the CPFG model, the corporation sells the land underlying its building to a tax-indifferent party. The tax-indifferent party then leases the land to investors pursuant to, for example, a 65 year ground lease with the first 20 years rent deferred with compounding interest at the investors' option. The corporation then sells its building to the investors and leases both the land and building back from the investors for a twenty year term. At the end of the lease term to the corporation, the investors must pay the accrual due to the tax-indifferent party or relinquish the property to the tax-indifferent party. If the accrued obligation is fully paid in cash, the tax-indifferent party still obtains ownership of the building and return of the land upon the expiration of the ground lease, or sooner if the investors default thereunder. Thus, the CPFG model of certain exemplary embodiments enables the tax-indifferent party to acquire both the land and the building for the price of the land alone. The transaction provides a significant return to the tax-indifferent party similar to the effect of a zero-coupon bond. At the same time, the investors are able to receive a significant return on their investment, favorable treatment on their balance sheet due to leverage lease treatment, positive cash flow throughout the life of the lease, and significant tax benefits. This allows the investors to provide a favorable leaseback rate to the corporation and a high return to the tax-indifferent party. Moreover, the structure is now available for many more properties than simply those with historic buildings in need of renovation.

While the above-described techniques result in advantages to a corporation, certain exemplary embodiments may extend such techniques to confer related advantages to building owners and/or developers. As will be described in further detail below, the building owner or developer may sell the land to a tax-indifferent party. The building owner or developer then may lease back the land under a long-term ground lease which provides the ground lessee the option to defer and accrue its ground rent obligations for an initial period as described in the CPFG model. The building owner or developer then may lease the building and sublease the land to a creditworthy tenant. Finally, the building owner or developer may seek debt and equity investment either directly or into a company it would form to own the building and lease the land as described in the CPFG model. As such, one advantageous aspect of such embodiments relates to the ability for more parties to the transaction to realize financial benefits.

As indicated above, a suitable ground lease is used in transactions under the models described herein. The specific terms of the ground lease can vary as long as the objectives discussed herein are met. A sample ground lease that is preferably used when implementing the instant invention is included as Attachment 1 to the above-referenced provisional application. While the sample ground lease includes a 65 year lease with a 20 year initial deferral period, these time periods may vary depending on the particular implementation of the instant invention. As a general guideline, however, the length of the ground lease should be sufficient to qualify as a true sale under the applicable tax code (generally assumed to be over 50 years). Thus, in the preferred embodiment of the invention, the ground lease is for at least 50 years and possibly as long as 65 years or more. The length of the deferral period can also vary. However, it has been found that most implementations of the invention will use between 15 and 25 years (preferably 20 years) for this initial deferred payment period. The deferral period is preferably less than 75% of the estimated economic life of the building being leased. Of course, it will be appreciated that the invention is not limited to use with the specific terms of the sample ground lease.

### BRIEF DESCRIPTION OF THE DRAWINGS

These and other features, objects, and advantages of the instant invention will become apparent from the following detailed description of the invention, when read in conjunction with the appended drawings, in which:

FIG. 1A is a flowchart illustrating the main stages of a PFG structured transaction for financing properties, in accordance with a first embodiment involving the sale of an existing building;

FIG. 1B is a flowchart illustrating the main stages of an alternative to the embodiments described with reference to FIG. 1A, that reduces the need to ground lease the land;

FIG. 2A is a flowchart illustrating the main stages of a PFG structured transaction for financing properties, in accordance with a second embodiment involving the construction or renovation of a building;

FIG. 2B is a flowchart illustrating the main stages of an alternative to the embodiments described with reference to FIG. 2A, that also reduces the need to ground lease the land;

FIG. 3 is a flowchart illustrating a first exit strategy for a PFG structured transaction in which the special purpose entity (“SPE”) established by the equity investors to own the building surrenders the building, in accordance with an exemplary embodiment;

FIG. 4 is a flowchart illustrating a second exit strategy for a PFG transaction in which the accrual is paid off, in accordance with an exemplary embodiment;

FIG. 5 is a structure diagram illustrating a first part of a PFG structured transaction involving the sale of an existing building, in accordance with the first embodiment shown in FIG. 1A;

FIG. 5A is a structure diagram illustrating an alternative first part of a PFG structured transaction involving the sale of an existing building, wherein a VIE is used as the land holder, in accordance with an embodiment shown in FIG. 1A;

FIG. 5B is a structure diagram illustrating an alternative first part of a PFG structured transaction involving the sale of an existing building, wherein a bargain purchase option is available under the ground lease, in accordance with an embodiment shown in FIG. 1A;

FIG. 6 is a structure diagram illustrating a second part of a PFG structured transaction involving the sale of an existing building, in accordance with the first embodiment shown in FIG. 1A;

FIG. 7 is a structure diagram of a third part of a PFG structured transaction involving the sale of an existing building, in accordance with the first embodiment shown in FIG. 1A;

FIG. 8 is a structure diagram of a first part of a PFG structured transaction involving the renovation or construction of a building, in accordance with the second embodiment shown in FIG. 2A;

FIG. 9 is a structure diagram of a second part of a PFG structured transaction involving the renovation or construction of a building, in accordance with the second embodiment shown in FIG. 2A;

FIG. 10 is a structure diagram of a third part of a PFG structured transaction involving the construction of a building, in accordance with the second embodiment shown in FIG. 2A;

FIG. 11 is a structure diagram of a third part of a PFG structured transaction involving the renovation of a building, in accordance with the second embodiment of the invention shown in FIG. 2A;

FIGS. 12A-12D illustrate the four stages of a PFG structured transaction, in accordance with an exemplary embodiment;

FIG. 13A is a flowchart illustrating the main stages of a CPFG structured transaction for financing properties, in accordance with a third embodiment;

FIG. 13B is a flowchart illustrating an alternative to the embodiments described with reference to FIG. 13A, that enables developers and/or owners to realize financial benefits of the structured transaction;

FIG. 13C is a flowchart illustrating the main stages of an alternative to the embodiments described with reference to FIG. 13A, that also reduces the need to ground lease the land;

FIG. 14 is a flowchart illustrating a first exit strategy for a CPFG structured transaction in which the accrual is paid off, in accordance with an exemplary embodiment;

FIG. 15 is a flowchart illustrating a second exit strategy for a CPFG transaction in which the SPE surrenders the building, in accordance with an exemplary embodiment;

FIG. 16 is a structure diagram illustrating a first part of a CPFG structured transaction, in accordance with the embodiment shown in FIG. 13A;

FIG. 16A is a structure diagram illustrating an alternative first part of a CPFG structured transaction wherein a VIE is used as the land holder, in accordance with the embodiment shown in FIG. 13A;

FIG. 16B is a structure diagram illustrating an alternative first part of a CPFG structured transaction wherein a bargain purchase option is available under the ground lease, in accordance with the embodiment shown in FIG. 13A;

FIG. 17 is a structure diagram illustrating a second part of a CPFG structured transaction, in accordance with the embodiment shown in FIG. 13A;

FIG. 18 is a structure diagram of a third part of a CPFG structured transaction, in accordance with the embodiment shown in FIG. 13A;

FIG. 19 shows the economics upon closing of a CPFG structured transaction, in accordance with an exemplary embodiment; and

FIGS. 20A-20D illustrate the four stages of a CPFG structured transaction, in accordance with an exemplary embodiment.

### DETAILED DESCRIPTION OF THE INVENTION

As indicated above, the exemplary embodiments herein provide improved real estate funding models that have beneficial results for the parties to the transaction. The first model is referred to as the PFG model and the second model is referred to as the CPFG model. These two models will be described in detail below.

There are often various issues facing tax-exempt entities. These issues may include a need for cash to fund projects, for example. However, a tax-exempt entity may be unwilling or unable to utilize bonding capacity to raise cash. In addition, the tax-exempt entity may have strained debt capacity. The PFG model of certain exemplary embodiments addresses these and other issues by providing an innovative sale/leaseback structure that converts a tax-exempt entity's real estate into cash. However, as will become clear by the following description, the instant invention is not limited to the sale/leaseback structure. Rather, certain exemplary embodiments instead provide alternate exemplary financing structures that allow the land and building to be owned by the same person or entity when such a structure would be advantageous. The PFG model not only provides cash for the tax-exempt entity, but it also allows the tax-exempt entity to retain control and retake ultimate ownership of the property.

The PFG model provides more up-front cash to the tax-exempt entity than can be achieved using traditional debt financing through the sale of an existing building. The PFG model also enables construction or rehabilitation of a tax-exempt entity's building without encumbering assets or invading capital. In addition, the PFG model can give the tax-exempt entity operating leaseback having long-term fixed rates with renewals at discounted rates. The PFG model can also have attractive exit strategies allowing for reclamation by the tax-exempt entity of the entire property without additional payment. The PFG model also gives the tax-exempt entity control of the building use during the lease.

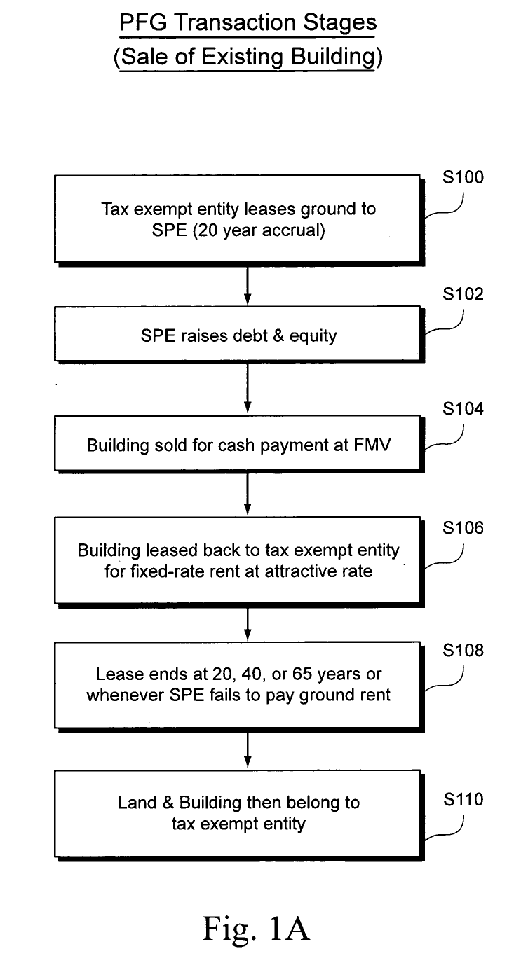

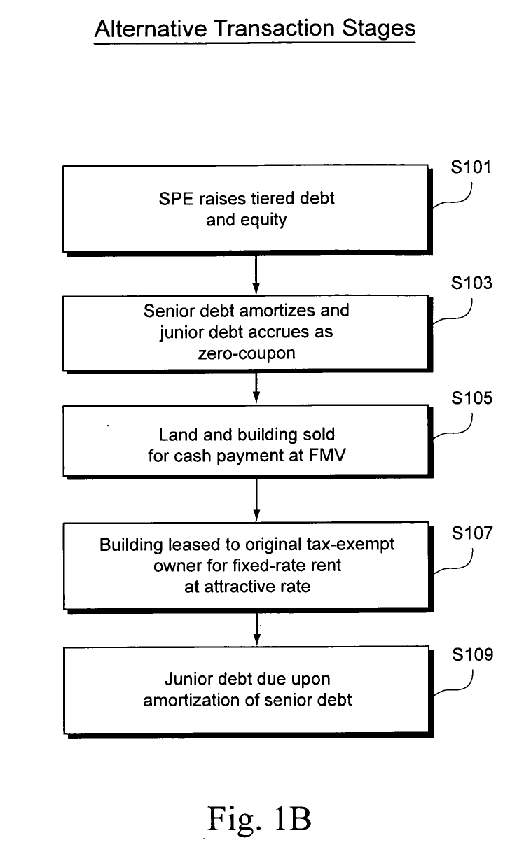

FIG. 1A is a high-level flowchart illustrating the main stages of a PFG structured transaction for financing properties, in accordance with a first embodiment involving the sale of an existing building owned by a tax-exempt (or tax-indifferent) entity. While this structure may appear less advantageous because of recent tax law changes, it establishes the base PFG structure upon which other exemplary embodiments are based. In the first step of this embodiment (step S100), the tax-exempt entity leases its ground to the SPE. In the next step (step S102), the SPE raises debt and equity for use in purchasing the building. The tax-exempt entity then sells the building to the SPE for a cash payment at FMV (step S104). The building is then leased back to the tax-exempt entity for fixed-rate rent at an attractive rate (step S106). The ground rent is then accrued, as in this example, for 20 years with interest. The lease ends at, for example, 20, 40 or 65 years or whenever the SPE fails to pay ground rent (step S108). The land and the building then belong to the tax-exempt entity (step S110).

As noted above, the instant invention is not limited to the ground lease structure. Using such techniques, the need for retention and ground lease of land by the tax-exempt entity is reduced. In this variant, the land and building may be purchased and owned by the same person or entity. The property owner leases both the land and building back to the tax-exempt entity. The property owner would obtain tiered debt financing from third-party lenders unrelated to the property owner or tax-exempt entity. The senior debt is likely to come from an institutional lender and may or may not amortize during the lease term. It would have a first place security position on the property. The property owner would then obtain subordinate debt in one or more tranches from tax-indifferent lender parties. The subordinate debt would not require any payment until it matures which may be before, at, or after the termination of the lease but which is expected to occur at the same time as, or after, the senior debt is retired. Interest would compound on the deferred principal accruing under the subordinate debt. Both the senior and the subordinate debt could be non-recourse to the property owner but the property owner must surrender the property at foreclosure if either the senior or subordinate debt is not paid when due. The accrual under the subordinate debt works in the same manner as the ground rent accrual under the basic financing model.

All or part of the subordinate debt may be insured under residual value insurance, thereby ensuring that the property value will be sufficient to provide a fixed yield to the insured subordinate lender. If the property owner fails to pay the insured subordinate debt when due and the insured subordinate debt were not satisfied through foreclosure or other means, the residual value insurer would fully redeem the insured subordinate debt and accede to the position of the insured subordinate debt holder. It is anticipated that such residual value insurance would reduce the interest rate that must be paid on that portion of the subordinate debt covered by the residual value insurance.

This structure is reflected in FIG. 1B, which is a flowchart illustrating the main stages of an alternative to the embodiments described with reference to FIG. 1A, that reduces the need to ground lease the land. In the first step (step S101), the SPE raises tiered debt and equity. In the next step (step S103), the senior debt amortizes and the junior debt accrues as a zero-coupon. Next (step S105), the land and the building are sold for a cash payment at the fair market value. The building would be leased to its original tax-exempt owner at an attractive fixed-rate rent (step S107). Finally (step S109), the junior debt would be due upon the amortization of the senior debt).

Because the land and building ownership are not bifurcated according to this embodiment, the property owner would be able to treat the building as a capital asset. Based on the analysis further described herein, the lease may be structured as a leveraged lease for the property owner and an operating lease for the tenant. This alternative arrangement creates an innovative financing model, under applicable accounting standards regardless of the accounting treatment obtained for the lessor or the lessee. A benefit of this exemplary arrangement is that the accrual may grow higher as it will be measured against the estimated future value of both the land and building, rather than just the building as under certain other exemplary embodiments, for purposes of determining the federal income tax consequences of the lease transaction.

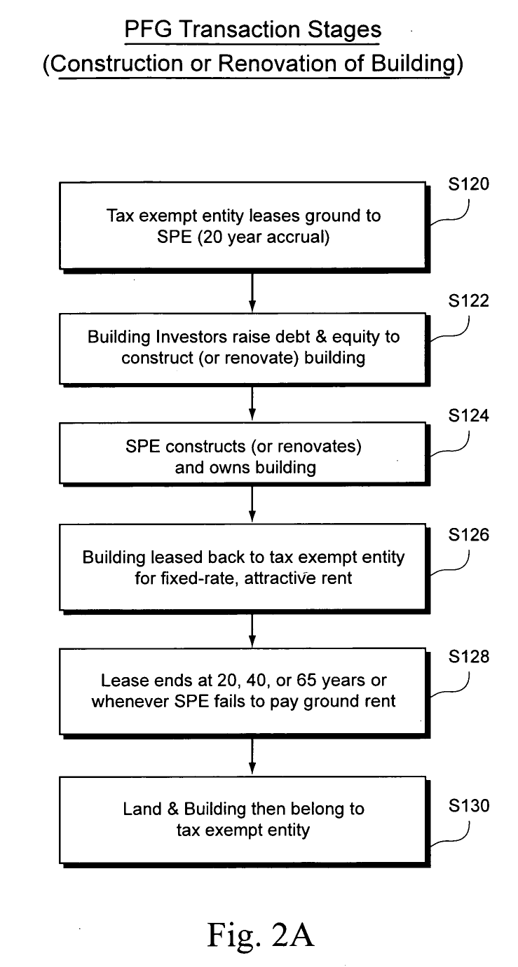

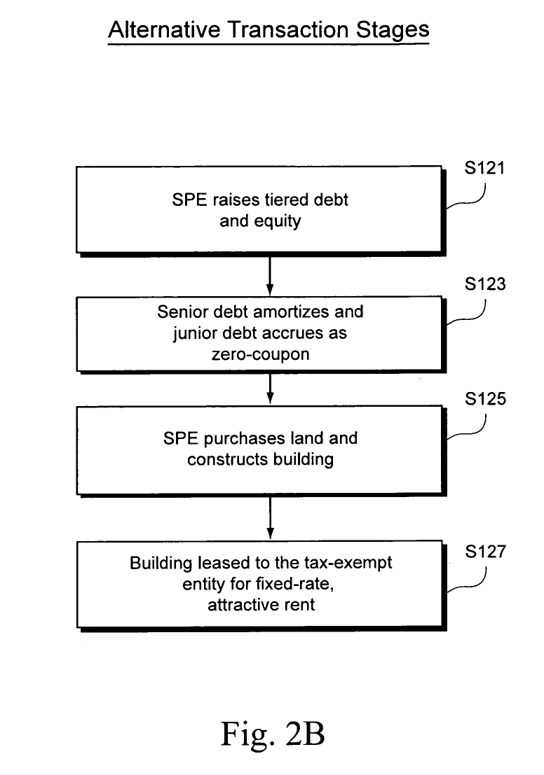

FIG. 2A is a high-level flowchart illustrating the main stages of a PFG structured transaction for financing properties, in accordance with a second embodiment involving the construction or renovation of a building owned by a tax-exempt entity. In the first step of this embodiment (step S120), the tax-exempt entity leases its ground to the SPE. In the next step (step S122), the SPE raises debt and equity to construct or renovate the building. The SPE then constructs (or renovates) and takes ownership of the building (step S124). The building is then leased back to the tax-exempt entity at an attractive rent (step S126). The ground rent accrues for, for example, 20 years with interest. The lease then ends at, for example, 20, 40 or 65 years or whenever the SPE fails to pay ground rent (step S128). The land and the building then belong to the tax-exempt entity (step S130).

FIG. 2B is a flowchart illustrating the main stages of an alternative to the embodiments described with reference to FIG. 2A, that also reduces the need to ground lease the land. Under this modified arrangement of the accruing debt structure described with respect to FIG. 1B, the property owner would acquire land from the tax-exempt entity or a third party and construct or renovate thereon a building to the specifications of the tax-exempt entity, which would lease the land and building. The property owner would also seek equity investment directly or into a partnership or limited liability company it may establish to own the property. It therefore would benefit from the tax deductions available with respect to, for example, the property depreciation, interest deductions for interest paid currently under the senior debt and for interest accruing under the subordinate debt, and other deductions available with respect to property ownership. Again, the accrual may be greater than under the ground lease variant, allowing for more advantageous benefits for the property owner. Also, the property owner may or may not seek leveraged lease treatment, and the lessee may or may not seek operating lease treatment. Again, this alternative arrangement creates an innovative financing model, under applicable accounting standards regardless of the accounting treatment obtained for the lessor or the lessee.

The basic steps are set forth in FIG. 2B. In the first step (step S121), the SPE raises tired debt and equity. In the next step (step S123), the senior debt amortizes and the junior debt accrues as a zero-coupon. Then (step S125), the SPE purchases the land and constructs or renovates the building. Finally (step S127), the building is leased to the tax-exempt entity for a fixed-rate, attractive rent. Optionally, the zero-coupon debt may carry residual value insurance, in the above-described manner.

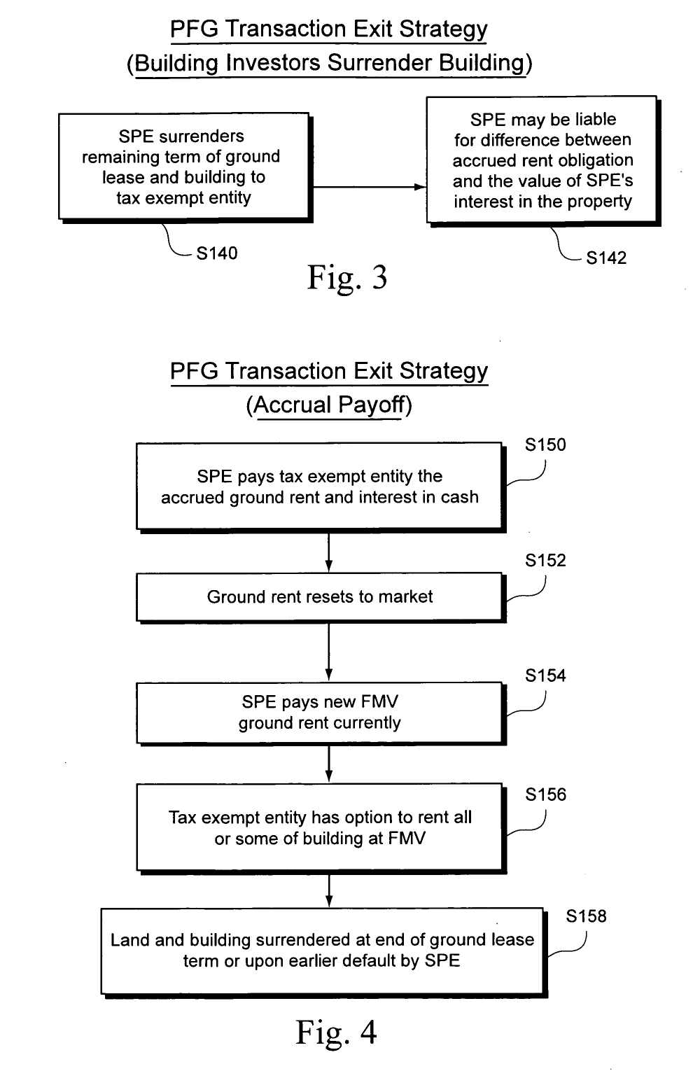

There are at least two exit strategies for the base PFG transaction. The first exit strategy involves a surrender of the building by the SPE and is illustrated in FIG. 3. As shown in FIG. 3, in this exit strategy, the SPE surrenders the remaining term of the ground lease and the building to the tax-exempt entity (step S140). The SPE may or may not then be held liable for the difference between the accrued rent obligation and the value of the SPE's interest in the property (step S142). This liability may or may not be assumed by the SPE's equity investors.

A second exit strategy is illustrated in FIG. 4. As shown in FIG. 4, in this second exit strategy, the SPE pays the tax-exempt entity the accrued ground rent and interest in cash (step S150). The ground rent then resets to market (step S152). The SPE then pays new FMV ground rent currently (step S154). The tax-exempt entity then has the option to rent all or some of the building at FMV (step S156). The building is then surrendered at the end of the ground lease term (or upon any earlier default by the SPE) (step S158).

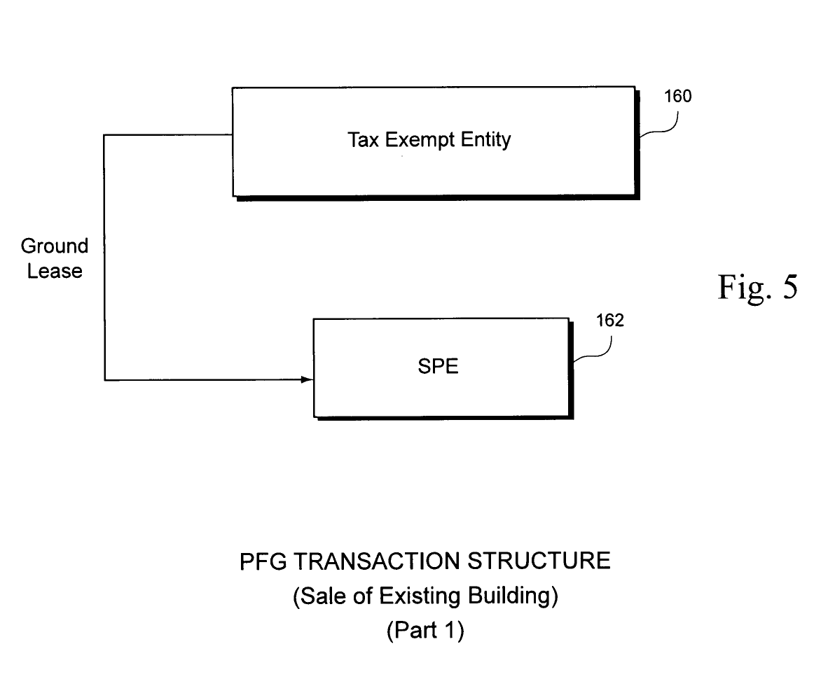

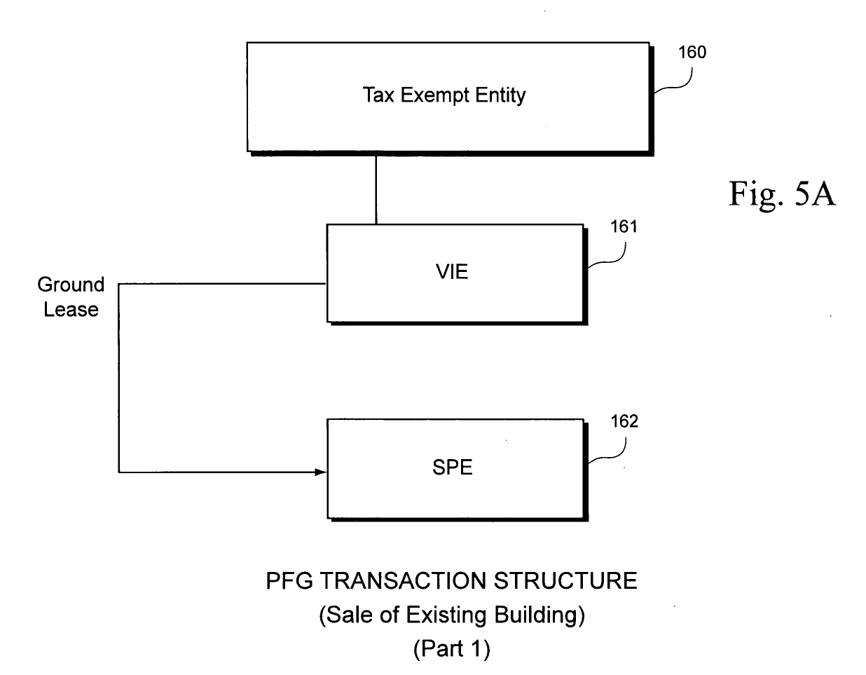

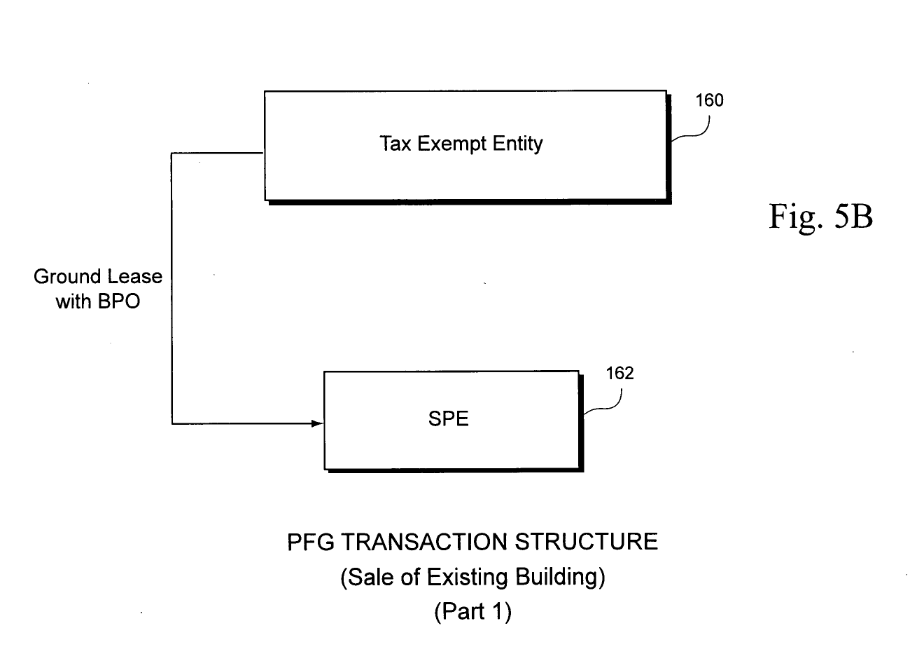

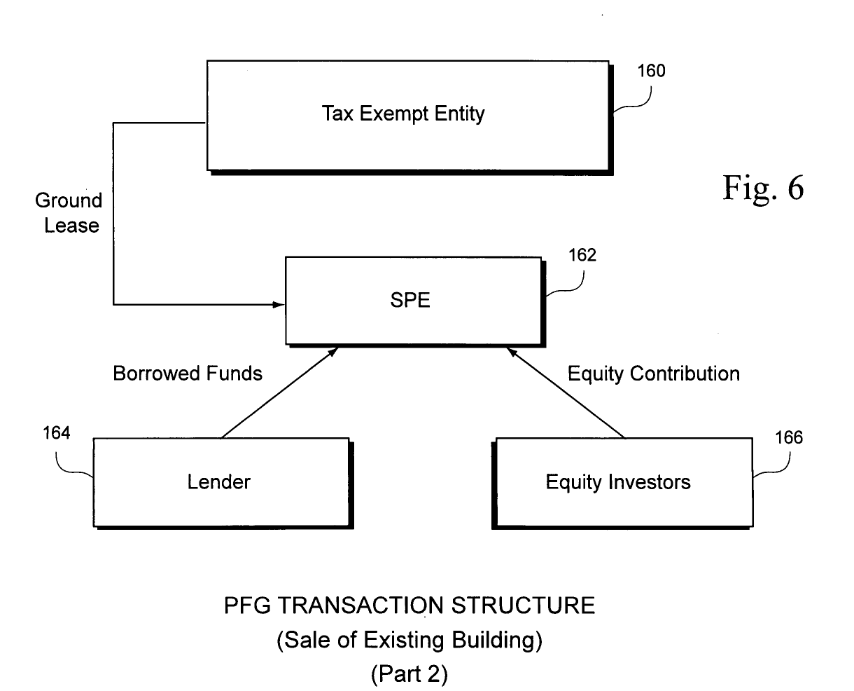

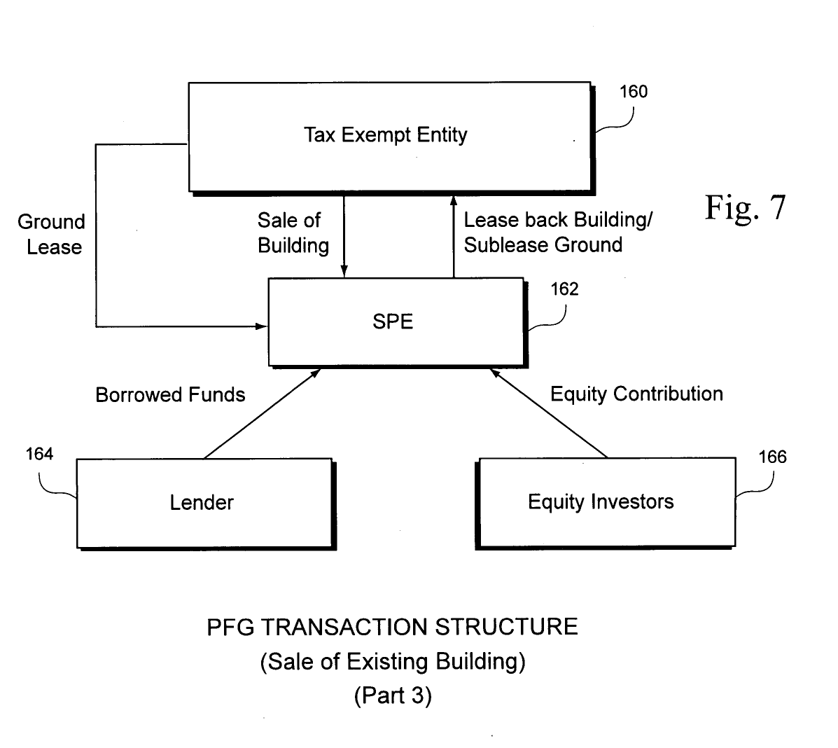

FIGS. 5-7 are structure diagrams illustrating the main parts of a PFG structured transaction involving the sale of an existing building, in accordance with the first embodiment shown in FIG. 1A. As shown in FIG. 5, the tax-exempt entity 160 leases its ground to the SPE 162. As shown in FIG. 6, the SPE 162 then, in this example, borrows funds from a lender 164 and obtains an equity contribution from equity investors 166. As shown in FIG. 7, the SPE 162 then purchases the building and the building is leased back to the tax-exempt entity 160.

FIG. 5A is a structure diagram illustrating an alternative first part of a PFG structured transaction involving the sale of an existing building, wherein a VIE is used as the land holder. In this alternative embodiment, the first step involves the creation of a VIE) 161 and the transfer of ownership of the land from the tax-exempt entity 160 to the VIE 161. The VIE then enters into the ground lease with the SPE 162. This alternative presents another possible method for achieving the desired accounting treatment for the SPE 162. Under FASB interpretation No. 46, “Consolidation of Variable Interest Entities” (an Interpretation of ARB No. 51) (“FIN46”), the SPE is required to account for the land as a capital lease and to consolidate the land owner's assets on its books in accordance with FASB 13 if a VIE is used under certain circumstances. The VIE is used to insure that the only asset to be consolidated is the land. Once the land is treated as a capital lease by the SPE, then the appropriate accounting treatment provides that the land lease will be a capital lease to the SPE, as long as the SPE guarantees a return to the VIE on its land position. This guarantee may be provided in the land lease or otherwise. The SPE applies FASB 13 to the building lease to determine the appropriate accounting treatment. As described herein, certain exemplary embodiments provide for capital lease treatment for the building through application of the 90% test. The SPE then combines the capital land lease with the capital building lease to achieve consolidated leverage lease treatment. It is noted that FIGS. 6 and 7 still apply to this alternative embodiment, except for the addition of the VIE (not shown in FIGS. 6 and 7). In addition, rather than being a leaseback of the building and a sublease of the ground, it will be a leaseback of both the building and the ground because the tax-exempt entity no longer owns the ground. Of course, it will be appreciated that these provisions may not apply when the above-described alternate embodiments that reduce the requirement of a ground lease are implemented.

FIG. 5B is a structure diagram illustrating another alternative first part of a PFG structured transaction involving the sale of an existing building, wherein a bargain purchase option is available under the ground lease, in accordance with an embodiment shown in FIG. 1. In this alternative method, the SPE receives an option to purchase the land at the termination of the land lease (typically 65 years). That option will generally be for a minimal amount (e.g., $1). Consequently, the lease of the land to the SPE will be a capital lease. The SPE applies FASB 13 to the building lease to determine the appropriate accounting treatment. As described herein, certain exemplary embodiments provide for capital lease treatment for the building through application of the 90% test. The SPE then combines the capital land lease with the building lease to achieve consolidated leverage lease treatment. This alternative requires the SPE to account for the land lease as a land purchase over the term of the lease. Consequently, Original Issue Discount (“OID”) treatment will be appropriate. Thus, payments made to the land owner will be considered installment purchase payments (including principle and interest) rather than rent. FIGS. 6 and 7 also apply to this alternative, although they do not show the bargain purchase option.

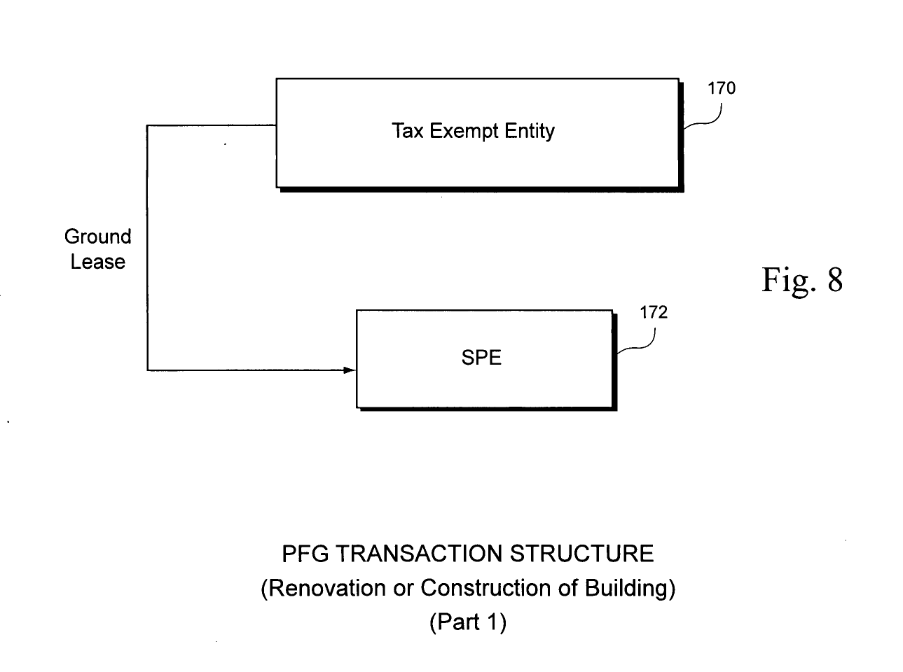

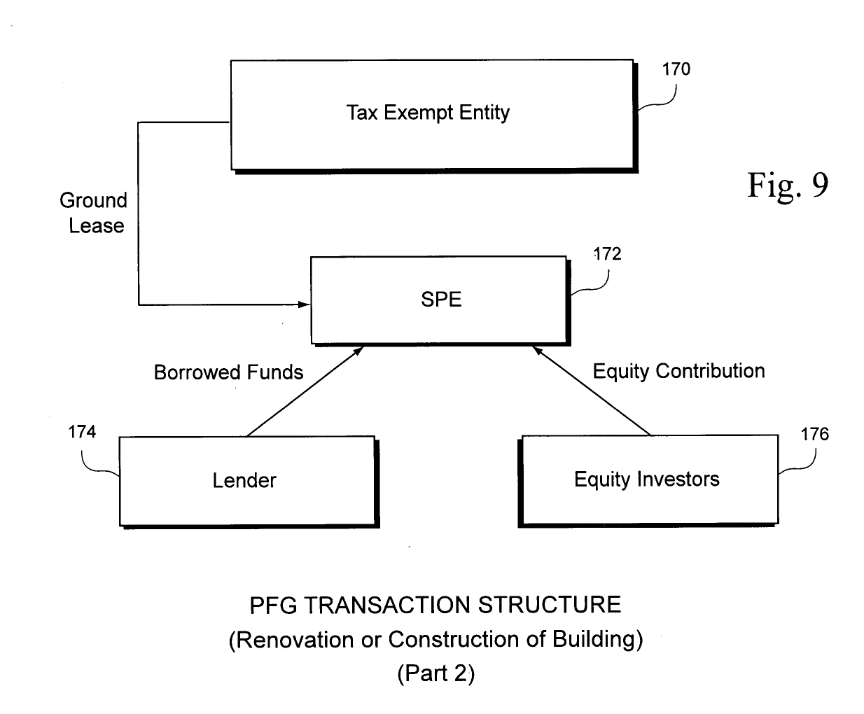

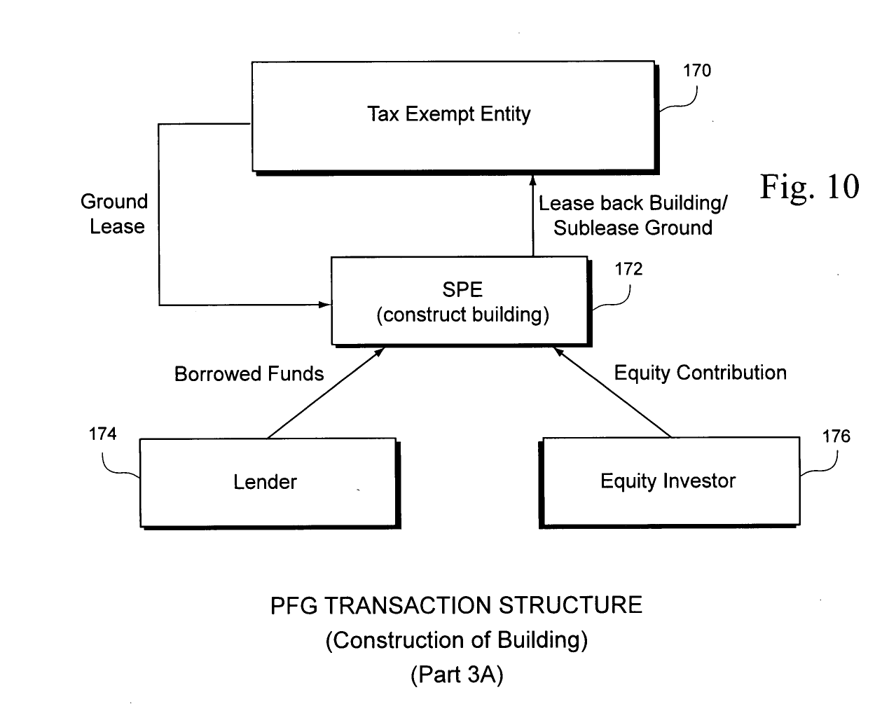

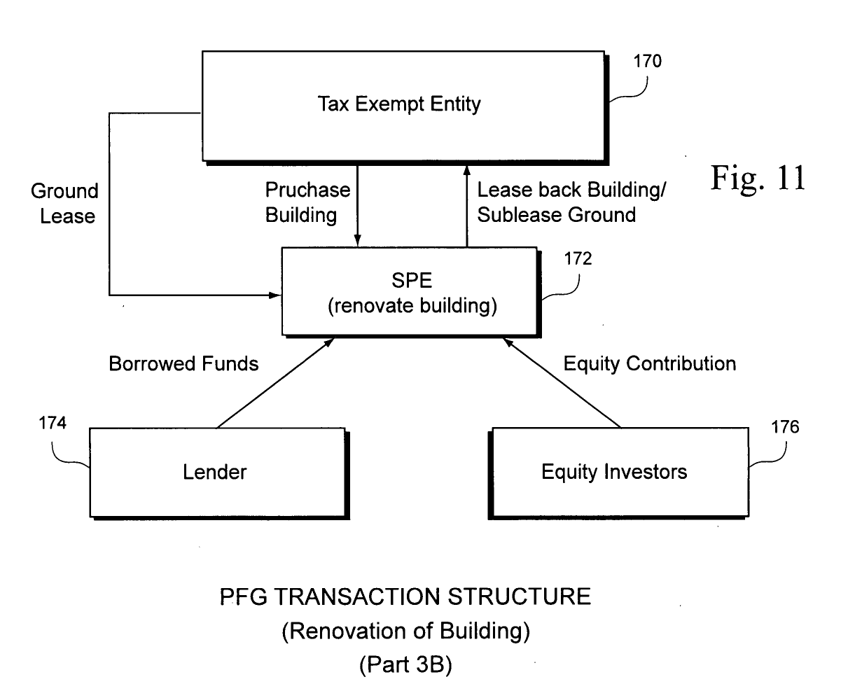

FIGS. 8-11 are structure diagrams illustrating the main parts of a PFG structured transaction involving the renovation or construction of a building, in accordance with the second embodiment shown in FIG. 2A. As shown in FIG. 8, the tax-exempt entity 170 leases the ground to the SPE 172. As shown in FIG. 9, the SPE, in this example, borrows funds from a lender 174 and receives an equity contribution from equity investors 176. The SPE 172 then constructs or renovates the building in accordance with the tax-exempt entity's specifications, and obtains ownership of the building. FIG. 10 illustrates the situation in which the SPE constructs the building. FIG. 11 illustrates the situation in which the SPE renovates an existing building. As shown in FIGS. 10 and 11, the constructed or renovated building is then leased back to the tax-exempt entity 170. It is noted that the alternative methods of using a VIE or a bargain purchase option, as described above in connection with FIGS. 5A and 5B, can be applied in a similar manner to a PFG transaction involving the construction or renovation of a building. It also is noted that such steps may be modified, or even may not be required, when the above-described alternate embodiments that reduce the requirement of a ground lease are implemented.

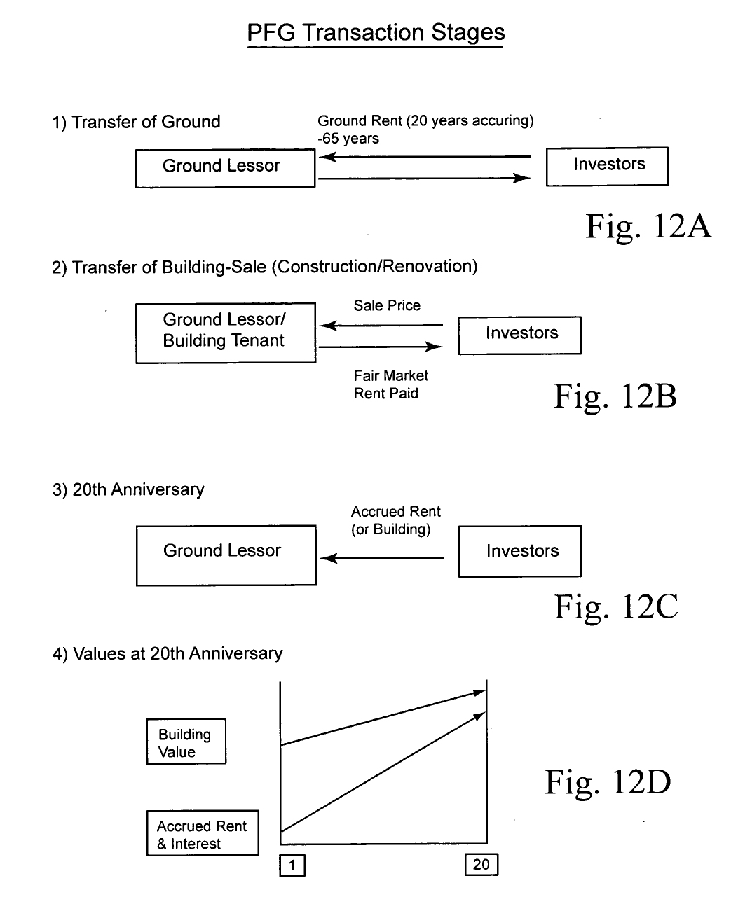

FIGS. 12A-12D illustrate the four stages of an exemplary PFG structured transaction. Specifically, FIG. 12A illustrates the transfer of ground. FIG. 12B illustrates the lease of the building. FIG. 12C illustrates the accrued rent being paid or the building being given to the ground lessor at the 20^{th} anniversary. FIG. 12D illustrates the value of the building relative to the accrued rent and interest at the 20^{th} anniversary.

As indicated above, in the PFG model, the original owner of the land and building is the lessor of the land but the lessee of the building pursuant to its leaseback. In accordance with certain exemplary embodiments, by “netting” the payment stream of the land rent against that of the building rent, the minimum lease payments for the original land owner/building lessee are decreased. This payment stream is then compared with the FMV of the real property, both land and building, to determine whether the 90% test of FASB 13 is met. This netting effect has a significant affect on lease classification under FASB 13. If the present value of the entire rent payment stream were considered and exceeded 90% of the FMV of the real property, then the lessee would have to capitalize the building asset. Thus, the tax-exempt entity would be required to reflect on its balance sheet ownership of the building in addition to the land which is already reflected on its balance sheet. However, under the PFG model, the “net” of the ground rent and the building rent are used in determining the FASB 13 calculation. After netting, the present value does not exceed 90% of the FMV of the property and, as a result, the tax-exempt entity is able to obtain operating lease classification for the building.

The SPE in the above example would have a minimum lease payment equaling the rent received for the leaseback of the building together with sub-leasing of the land. Since the SPE acquired only the building, the lease payment is measured against the value of the building only, and not the land, to determine the SPE's implicit rate in the transaction. Thus, the SPE's present value rent calculation exceeds the 90% test of FASB 13, thereby resulting in capital lease classification for the building. Alternative embodiments are provided in which either a bargain purchase option is utilized or a VIE is established to achieve the desired accounting treatment for the lessor (i.e., capital lease treatment on the land). As noted above, once the land lease is structured so as to achieve capital lease treatment, the leases of the building and the land are consolidated as a capital lease and the SPE is able to utilize leverage lease treatment. The result of the leverage lease treatment is that, under GAAP, the SPE and its equity investors no longer need to declare losses on their financial statements as a result of the transaction, because the gain recognized by the SPE in the twentieth year would be allocated over the initial years of the lease term, thereby offsetting the effects of the deductions taken during this period. The SPE and its equity investors then have both positive income on their financial statements and positive cash flow throughout the term of the building leaseback, as well as significant tax benefits from the transaction. As a result of the impact directly attributable to leverage lease treatment, the transactions no longer require as high a return as that provided from transactions utilizing tax credits under the original model. Thus, the transactions are no longer dependent on the historic rehabilitation tax credit and many more investors can advantageously take part in them.

In the PFG model, the original owner of the real property is generally a tax-indifferent or tax-exempt party. The CPFG model modifies the PFG model so that taxpaying entities, such as corporations, can sell their real property and lease it back at below market rental rates. The CPFG model also provides an innovative real estate investment for non-tax paying entities, such as pension funds. The innovative sale/leaseback structure of the CPFG model monetizes 100% of a corporate real estate asset at a low leaseback cost. The CPFG model also enables a pension fund, or other non-tax paying entity, to effectively purchase buildings for only the cost of the land underneath them.

Exemplary corporate sellers that could benefit from the CPFG model include, but are not limited to, companies seeking liquidity at long-term fixed rates, monetization of real estate assets, an improvement in earnings, a high ROA, or a restructuring of real estate synthetic leases. Under the CPFG model, corporations can sell real estate at appreciated FMV, realize capital gains versus book and achieve long-term, attractive fixed rate rents. A further benefit is that the leaseback is treated as an operating lease. Additional benefits include: monetizing appreciation trapped in real estate; providing lease renewals at a discount to FMV; and realizing 100% of value in the real estate.

With respect to the non-tax paying entity, such as pension funds, the benefits include: long-term secure yields of, for example, 11%; purchase of a building for the cost of the land alone; annual returns recorded as income; no need to mark to market; building tenant default risk mitigation; and attractive exit strategies.

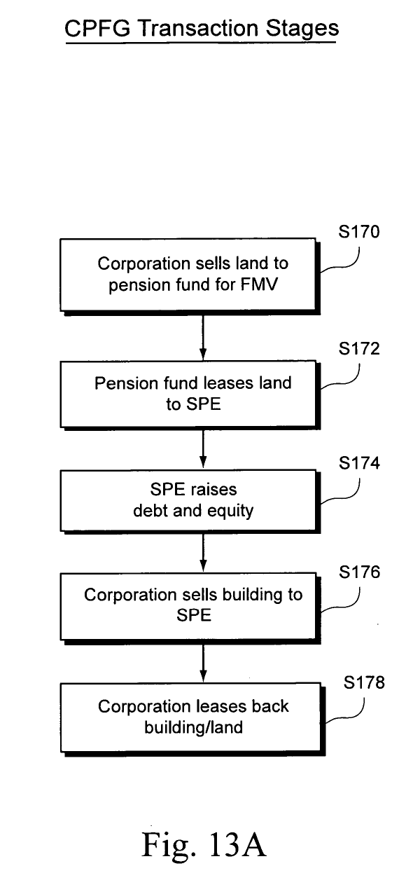

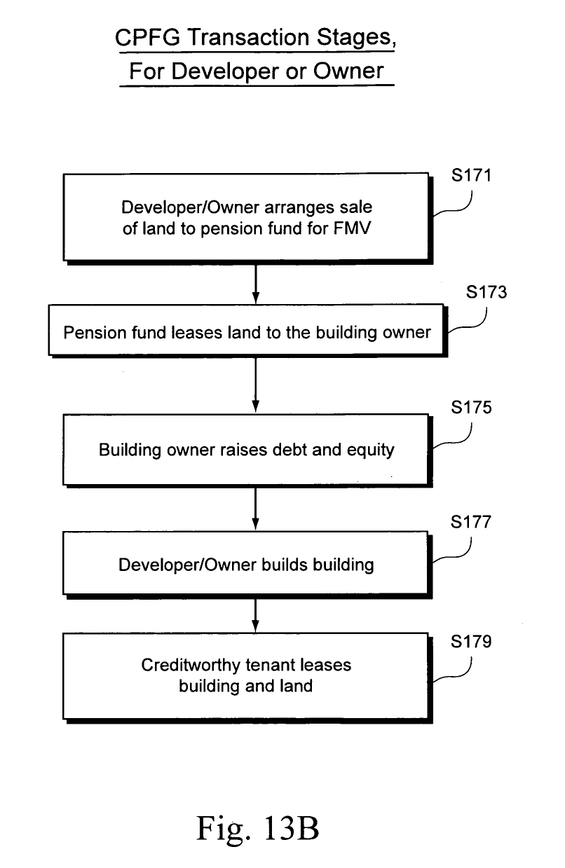

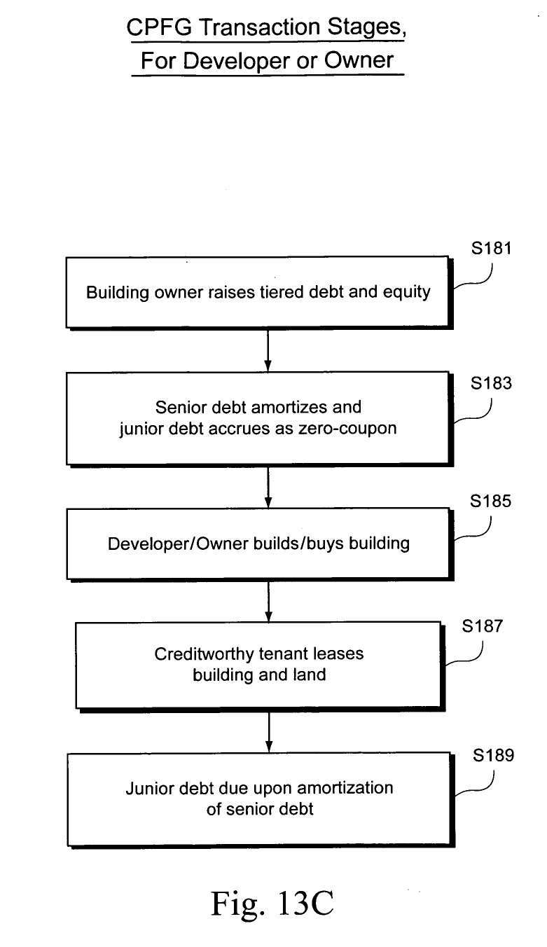

FIG. 13A is a high-level flowchart illustrating the main stages of a CPFG structured transaction. As shown in FIG. 13A, the first step (step S170) includes having the corporation sell land to the non-tax paying entity (e.g., pension fund) for FMV. In the next step (step S172), the pension fund leases the land to a SPE. The SPE then raises debt and equity for purchasing the building (step S174). The corporation then sells the building to the SPE (step S176). Finally, the corporation leases back the building and the land (step S178).

Although the above-described examples propose having a corporation use the unique financial structure under the CPFG model, the instant invention is not so limited. Under a variant of the CPFG model described below with reference to FIG. 13B, an owner of a building for rent or a developer may also utilize the unique financing method. Specifically, a building owner or developer may sell the land underneath the building it owns or is constructing to a tax-indifferent party. The building owner or developer would then lease back the land pursuant to a long-term ground lease which provides the ground lessee the option to defer and accrue its ground rent obligations for an initial period as described in the CPFG model. The building owner or developer would lease the building, and sublease the land, to a creditworthy tenant. Optionally, the building may be leased prior to the sale/leaseback of the land, in which event the land would be sold and leased subject to the building lease. The building owner or developer would seek debt and equity investment either directly or into an organized entity (e.g., a partnership or limited liability company) it would form to own the building and lease the land as described in the CPFG model. Thus, it will be appreciated that under this variant of the CPFG model, the advantageous financing methods are extended so that they may be used by current owners of buildings for rent or developers of commercial rental property.

Briefly, FIG. 13B is a flowchart illustrating an alternative to the embodiments described with reference to FIG. 13A, that enables developers and/or owners to realize financial benefits of the structured transaction. A developer/owner first arranges for the sale of the land to a pension fund for the fair market value (step S171). The pension fund then leases the land to the building owner (e.g., the developer or its designee) (step S173). The building owner raises debt and equity (step S175), and the developer or building owner builds the building (step S177). Finally, a creditworthy tenant leases the building and land (step S179).

FIG. 13C shows another exemplary embodiment of the CPFG model, which reduces the need for a sale and leaseback of land. Under this variant, similar to the variants to the PFG model described in FIGS. 1B and 2B, the land and building are owned by the same person or entity. The property owner leases both the land and building to a creditworthy tenant. The property owner would obtain debt financing from third-party lenders unrelated to the property owner or tenant. The senior debt is likely to come from an institutional lender, and it may or may not amortize during the lease term. It would have a first place security position on the property. The property owner would then obtain subordinate debt in one or more tranches from lenders, which are tax-indifferent parties. The subordinate debt would not require any payment until it matures, which may be before, at, or after the termination of the lease, but which is expected to occur at the same time as, or after, the senior debt is retired. Interest would compound on the deferred principal accruing under the subordinate debt. Both the senior and the subordinate debt could be non-recourse to the property owner, but the property owner must surrender the property at foreclosure if either the senior or subordinate debt is not paid when due. The accrual under the subordinate debt would work in the same manner as the ground rent accrual under the basic financing model.

Under a variant of this embodiment of the CPFG model, all or part of the subordinate debt may be insured under residual value insurance, which would insure that the property value will be sufficient to provide a fixed yield to the insured subordinate lender. If the property owner fails to pay the insured subordinate debt when due and the insured subordinate debt were not satisfied through foreclosure or other means, the residual value insurer would fully redeem the insured subordinate debt and accede to the position of the insured subordinate debt holder. Such residual value insurance would reduce the interest rate that must be paid on that portion of the subordinate debt covered by the residual value insurance.

Because the land and building ownership are not bifurcated under this embodiment of the CPFG model, the property owner will be able to treat the building as a capital asset. Based on the analysis herein, the lease may be structured as a leveraged lease for the property owner and an operating lease for the tenant. A benefit of this variant is that the accrual may grow higher as it will be measured against the estimated future value of both the land and building, rather than just the building as under previous variants, for purposes of determining the federal income tax consequences of the lease transaction.

Under a further variant of this embodiment of the CPFG model, the property owner would also seek equity investment directly or into a partnership or limited liability company it may establish to own the property and would benefit from the tax deductions available with respect to the property depreciation, interest deductions for interest paid currently under the senior debt and for interest accruing under the subordinate debt, and other deductions available with respect to property ownership. Under this variant, the property owner may or may not seek leveraged lease treatment, and the lessee may or may not seek operating lease treatment. This variant creates an innovative financing model, regardless of the accounting treatment obtained for the lessor or the lessee.

The basic steps are set forth in FIG. 13C. In the first step (step S181) the building owner raises tiered debt and equity for purchasing the land and building or purchasing the land and constructing the building. The senior debt amortizes and the junior debt accrues as a zero-coupon (step S183). In the next step (step S185) the building owner constructs (or buys) the building. The building owner leases the building and land to a creditworthy tenant (e.g., the corporation initiating the transaction in the CPFG model) (step S187). Finally, in step S189, the junior debt is due upon amortization of the senior debt.

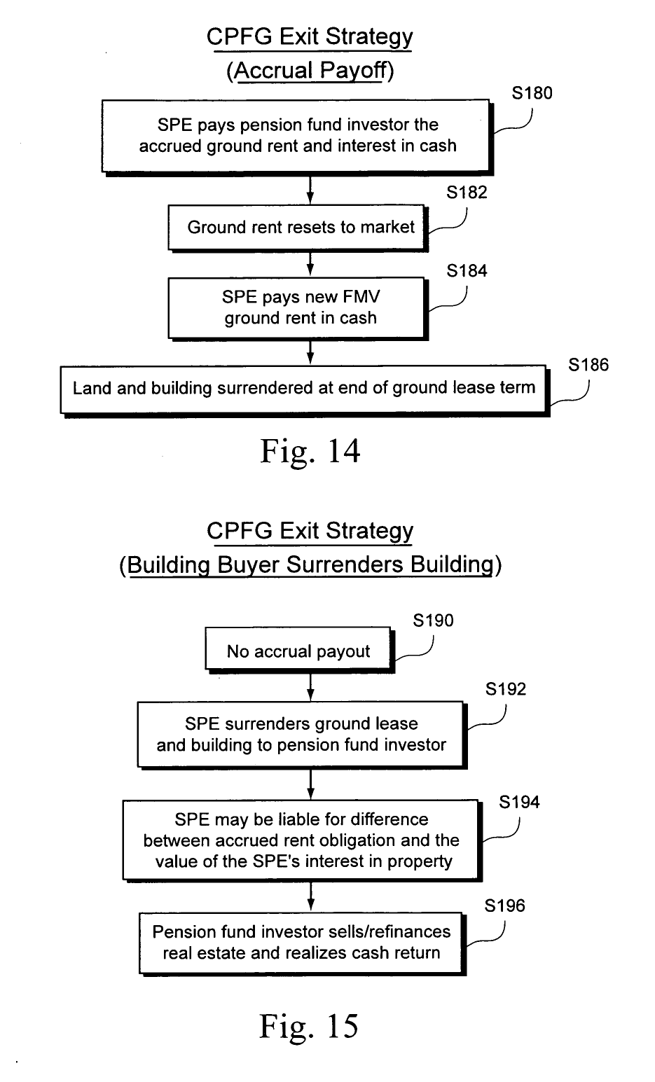

FIG. 14 is a flowchart illustrating a first exit strategy for an exemplary CPFG structured transaction in which the accrual occurs under the ground lease and is paid off. As shown in FIG. 14, in this exit strategy, the SPE pays the pension fund investor the accrued ground rent and interest in cash (step S180). The ground rent then resets to market (step S182). The SPE then pays the new FMV ground rent in cash (step S184). Then, the building is surrendered at the end of ground lease term (step S186).

FIG. 15 is a flowchart illustrating a second exit strategy for an exemplary CPFG transaction in which the accrual occurs under the ground lease and the SPE surrenders the building. As shown in FIG. 15, there is no accrual payout made (step S190). Instead, the SPE surrenders the ground lease and building to the pension fund investor (step S192). The SPE may or may not be liable for the difference between the accrued rent obligation and the value of the SPE's interest in the property (step S194); the equity investors in the SPE may or may not assume this liability. The pension fund investor may then sell/refinance the real estate asset and realize a cash return (step S196).

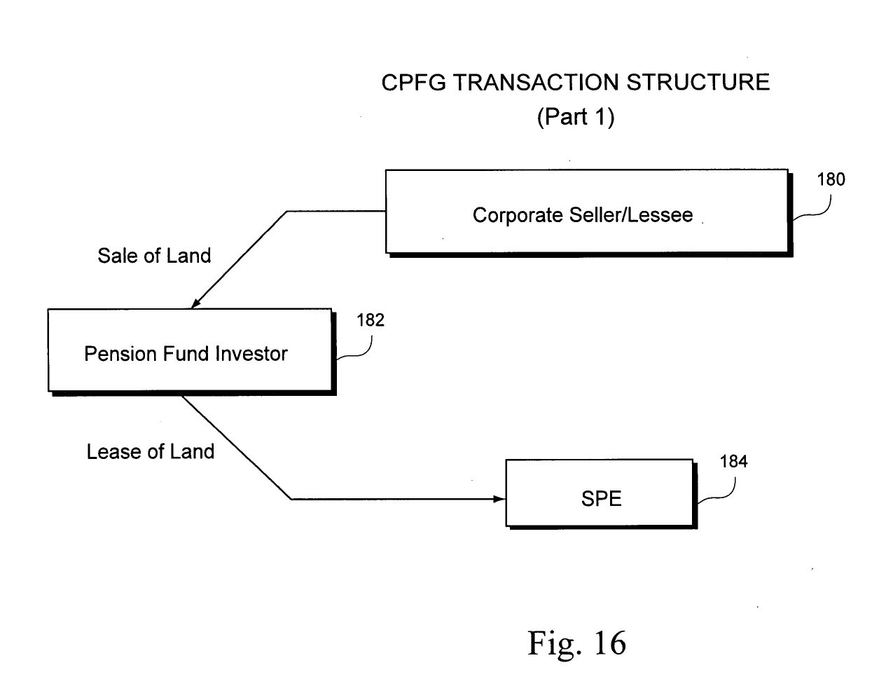

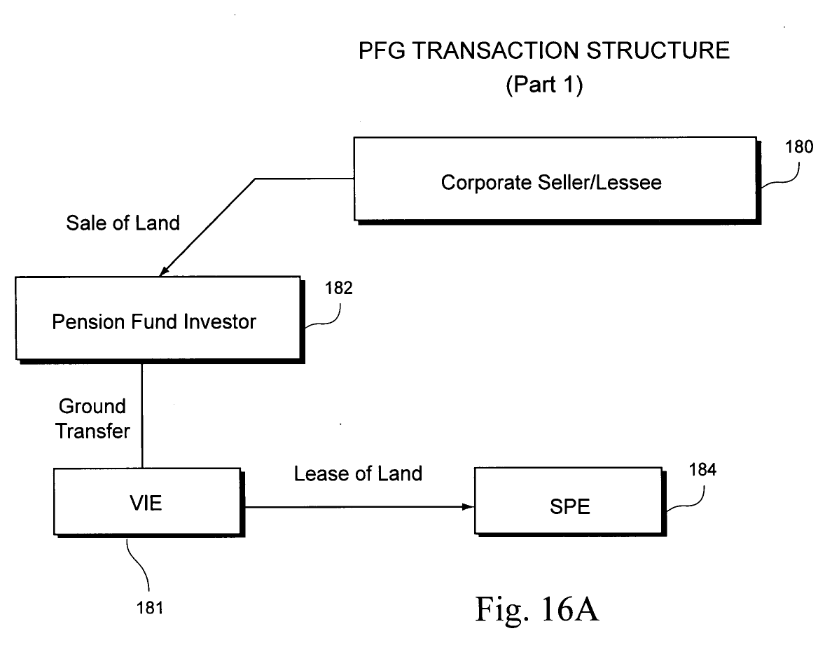

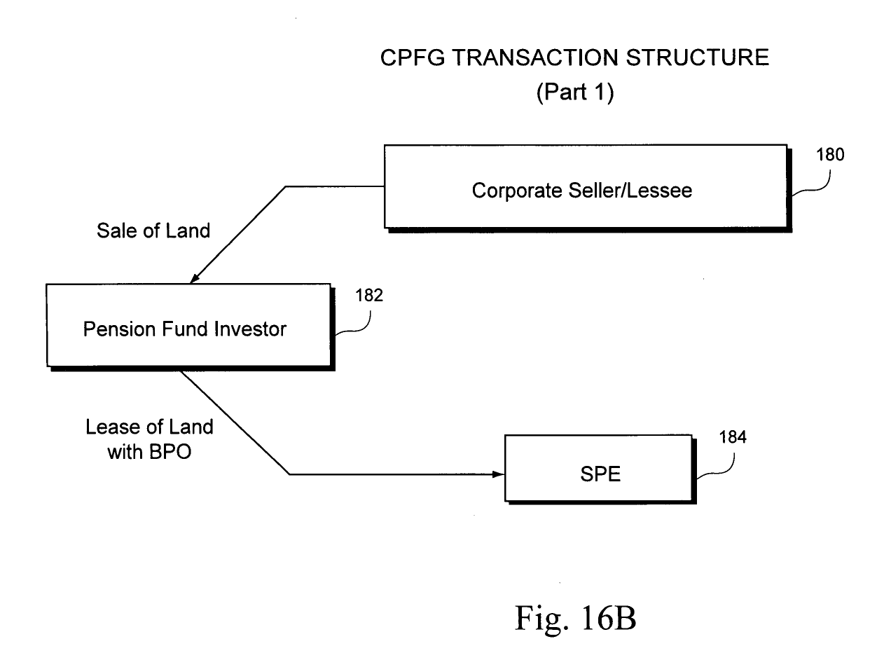

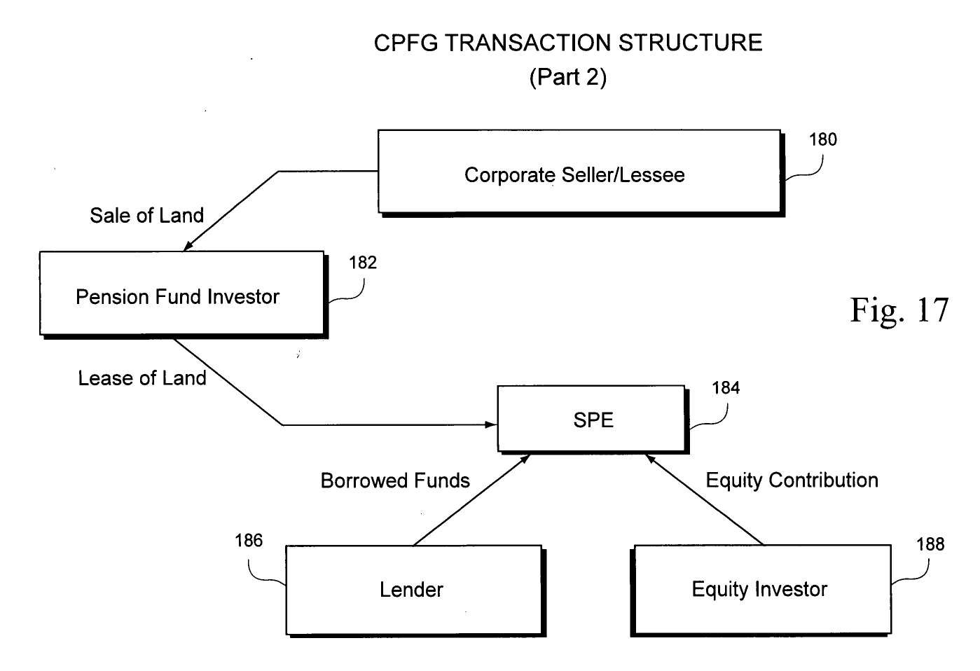

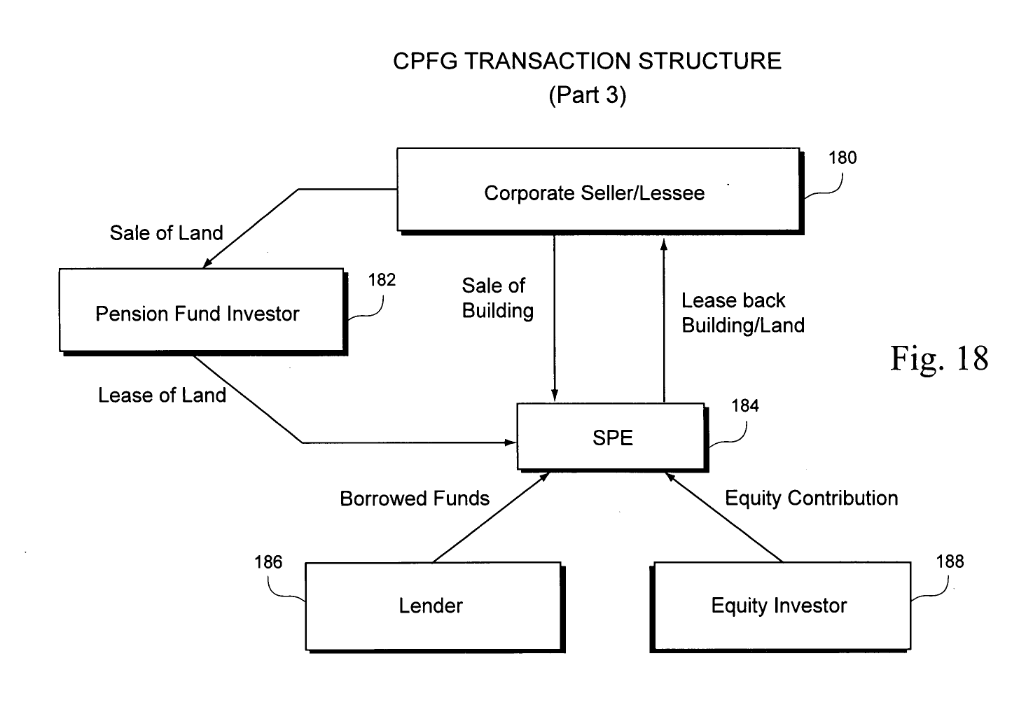

FIGS. 16-18 are structure diagrams illustrating the main parts of a CPFG structured transaction. As shown in FIG. 16, the corporation 180 sells the land to a pension fund (or other non-tax paying entity) 182 for FMV. The pension fund 182 leases the land to the SPE 184. As shown in FIG. 17, the SPE 184, in this example, borrows funds from a lender 186 and gets an equity contribution from an equity investor 188. As shown in FIG. 18, the corporation 180 then sells the building to the SPE 184. Then, the corporation 180 leases back the building and the land from the SPE 184.

FIG. 16A is a structure diagram illustrating an alternative first part of a CPFG structured transaction wherein a VIE 181 is used as the land holder, in accordance with the embodiment shown in FIG. 13A. In this alternative embodiment, the first step involves the creation of a VIE 181 and the transfer of ownership of the land from the pension fund investor 182 to the VIE 181. The VIE then enters into the ground lease with the SPE 184. This alternative presents another possible method for achieving the desired accounting treatment for the SPE 184. Under FASB interpretation No. 46, “Consolidation of Variable Interest Entities” (an Interpretation of ARB No. 51) (“FIN46”), the SPE is required to account for the land as a capital lease and to consolidate the land owner's assets on its books in accordance with FASB 13 if a VIE is used under certain circumstances. The VIE is used to insure that the only asset to be consolidated is the land. Once the land is treated as a capital lease by the SPE, then the appropriate accounting treatment provides that the land lease will be a capital lease to the SPE, as long as the SPE guarantees a return to the VIE on its land position. The guarantee may be provided in the land lease or otherwise. The SPE applies FASB 13 to the building lease to determine the appropriate accounting treatment. As described herein, certain exemplary embodiments provide for capital lease treatment for the building through application of the 90% test. The SPE then combines the capital land lease with the capital building lease to achieve consolidated leverage lease treatment. It is noted that FIGS. 17 and 18 still apply to this alternative embodiment, except for the addition of the VIE (not shown in FIGS. 17 and 18).

FIG. 16B is a structure diagram illustrating another alternative first part of a CPFG structured transaction wherein a bargain purchase option is available under the ground lease. In this alternative method, the SPE receives an option to purchase the land at the termination of the land lease (typically 65 years) from the pension fund investor. That option will generally be for a minimal amount (e.g., $1). Consequently, the lease of the land to the SPE will be a capital lease. The SPE applies FASB 13 to the building lease to determine the appropriate accounting treatment. As described herein, certain exemplary embodiments provide for capital lease treatment for the building through application of the 90% test. The SPE then combines the capital land lease with the building lease to achieve consolidated leverage lease treatment. This alternative requires the SPE to account for the land lease as a land purchase over the term of the lease. Consequently, OID treatment will be appropriate. Thus, payments made to the land owner will be considered installment purchase payments (including principal and interest) rather than rent. The affect of this is to decrease the allowable deductions to the SPE over the term of the operating lease by the amount of the payment allocated to principal. FIGS. 17 and 18 also apply to this alternative, although they do not show the bargain purchase option.

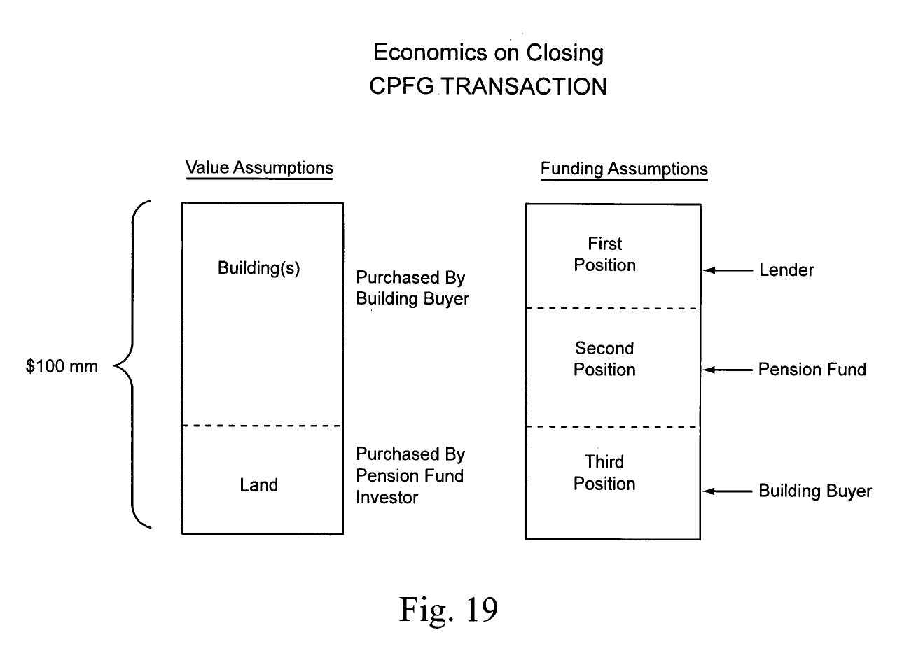

FIG. 19 illustrates the economics on closing for the exemplary CPFG transaction shown in FIGS. 16-18. In certain cases the land owner may partially or fully subordinate its interest in the property to the position of the lender to the SPE.

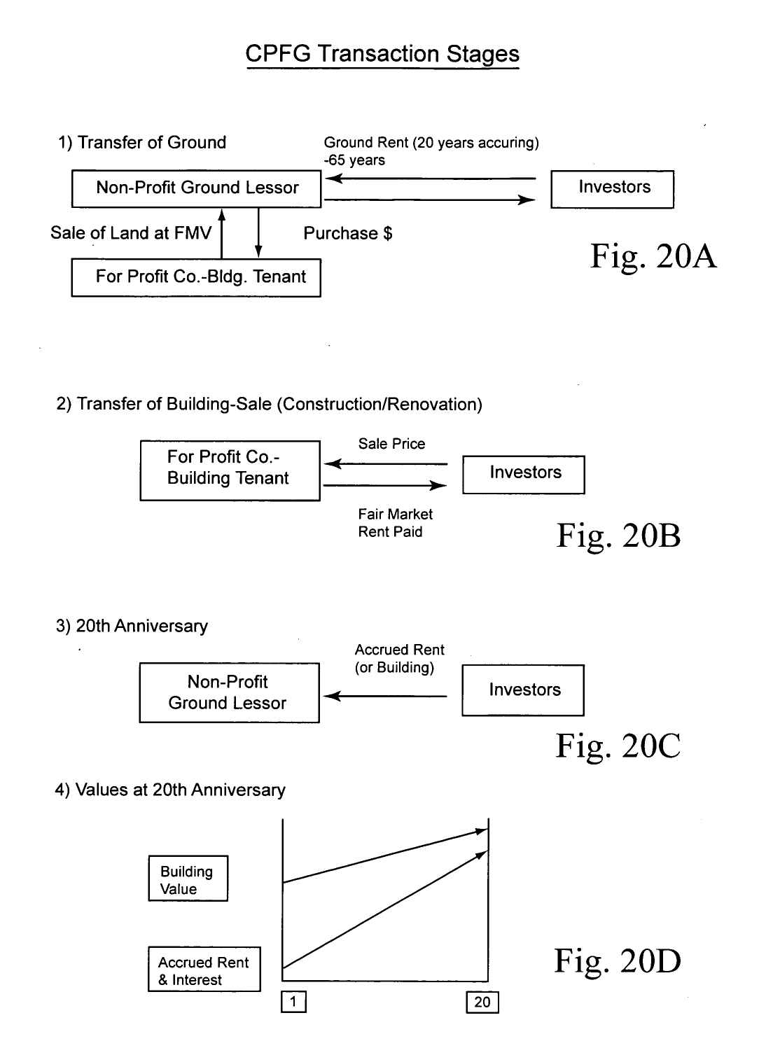

FIGS. 20A-20D illustrate the four stages of an exemplary CPFG structured transaction. Specifically, FIG. 20A illustrates the lease of ground. FIG. 20B illustrates the transfer of the building. FIG. 20C illustrates the accrued rent or the building being given to the ground lessor at the 20^{th} anniversary. FIG. 20D illustrates the value of the building relative to the accrued rent and interest at the 20^{th} anniversary.

As explain ed above, in the PFG transaction, the lessee passes the 90% FASB test because of the “netting” that is done using the ground rent or because of the use of a VIE. In a CPFG transaction, netting is not available because the lessee does not retain the land ownership and thus is not receiving any accrued ground rent on the land. However, the lessee in a CPFG transaction is still able to pass the 90% test, because of the accrual feature of the invention. Specifically, accrual still occurs in a CPFG transaction, and the accrual is being recorded as income by the non-tax paying entity that owns the land. That income to the non-taxing entity (e.g., pension fund) is an expense to the SPE and its equity investors. Since it is an expense that does not require a cash outflow, the SPE and its equity investors are able to achieve significant tax advantages. Because of those significant tax advantages, the SPE is able to charge less rent to the lessee in a CPFG transaction then the lessee would be able to receive in a straight sale/leaseback transaction with another type of structure. The lower rent to the lessee in a CPFG transaction allows the lessee to fall below the 90% rate on the FASB 13 4^{th} prong test. Thus, the accrual in a CPFG transaction is still instrumental in achieving the desired accounting treatment for the lessee in a CPFG transaction.

Generally, one difference between a CPFG transaction and a PFG transaction is that, under the PFG transaction, the entity that currently owns the land and the building is a non-tax paying entity. Consequently, the cost of money for this entity is at a tax exempt level, which is generally 150 basis points below the borrowing rate of a taxable entity of the same credit capacity. For example, a municipality like the District of Columbia may be able to borrow money at 5%. However, if this entity was not a municipality, it may have to borrow money at 6½%. In a CPFG transaction, the entity that initially owns the building and the land does not have tax-exempt money available to it. As a result, its cost of money is higher. However, because of the tax benefit that is passed through to the SPE in a CPFG transaction, it is able to charge less rent on the same building. As a result, the cost of money in the CPFG transaction is less than the borrowing rate and enables the 90% test to be passed.

Example PFG Transaction

As explained above, a significant advantage of certain exemplary embodiments is that the accruing asset can be netted against the building rent, thereby providing a lower net rent cost which enables the fourth prong of FASB 13 to be passed. The following provides a detailed description of how this fourth prong of FASB 13 is passed using an exemplary PFG transaction. The following facts, circumstances, and assumptions are used in this example PFG transaction:

Enterprise A, a non-tax paying entity, owns land and a commercial building on that land. The building is sold, transferring title to a substantially capitalized SPE (as further described below) for $85 million, which is the fair market value sales price. Enterprise A leases the building back from the SPE and subleases the land. Ownership in the underlying land, which is valued at $15 million, is retained by Enterprise A and is leased to the SPE for a 65 year lease term at fair market rental rates.

The SPE has one or more independent third party equity investors (the “Investor”) that makes an equity investment of $14.6 million representing approximately 17 percent of the fair value of the assets of the SPE at inception. The Investors are one or more substantial corporations (typically Fortune 1000 corporations) that are unrelated to the seller and have 100 percent voting control of the SPE. The equity investment represents an equity interest in legal form, is the only form of equity in the SPE, and is subordinate to all debt interests. There are no dividends, fees, or any other form of payments made to the Investor by the SPE that are in excess of the SPE's previously undistributed GAAP earnings throughout the life of the building lease.

The SPE has obtained non-recourse debt financing, which is provided by a financial institution independent of the SPE, the Investor, and Enterprise A. Enterprise A leases back the building and subleases the underlying land from the SPE for a 20 year term. In another embodiment involving a VIE, Enterprise A leases back both the building and the underlying land. Annual rental payments of $7.8 million are due in arrears. The total rental payments paid by Enterprise A for the leaseback of the building and sublease of the land (leaseback of the land in the VIE embodiment) over the 20 year lease term is $156 million, which is a fair market rental amount. The leaseback of the building contains the following terms and characteristics:
No transfer of ownership to Enterprise A at the end of the lease term;
No obligation and no option to purchase the building by Enterprise A;
No required payment by Enterprise A to the SPE for a decline in the fair value of the building;
No financing will be provided by Enterprise A to the SPE for any portion of the purchase price of the building;
The SPE will not share any portion of the appreciation of the building with Enterprise A;
Enterprise A's rental payment will be at fair market value and will not be contingent on any predetermined or determinable level of future operations of the SPE; and
Enterprise A will not sublease a portion of the building that would result in the present value of the rent for that portion being greater than 10 percent of the fair value of the building at the time of sale.

At the inception of the lease, the rate Enterprise A would incur to borrow the funds necessary to purchase the building over 20 years is 7 percent. Other than the rental payments owed to the SPE and the costs incurred by Enterprise A that relate to executory costs (e.g., insurance, maintenance, and taxes paid by the lessor), there are no other fees paid by Enterprise A to the owners of the SPE for structuring this lease transaction or for any other purpose.

Enterprise A leases the underlying land to the SPE with the following terms:
Lease term of 65 years with rent payments of approximately $2.2 million per year for the first 20 years of the underlying land lease, which are determined by an independent appraiser as fair market value.
The lease payments for year 1 through year 20 are structured as follows:
   The SPE may make annual payments; or
   The SPE may choose to defer the ground rent for the first 20 years. Any rent deferred will incur interest charges at an annual market rate, compounded annually. At the end of 20 years, all deferred rent amounts in addition to interest accrued must be paid in full.
In year 20, independent appraisers will determine the then-current fair market value lease payments for the next 20 years for the land. Another fair market valuation will be performed in year 40 to determine the annual lease payments for the remaining 25 years. Land lease payments will be due annually after year 20.
At lease inception, it is reasonable to assume that the SPE will not make the annual land lease payments, but will defer payment and accrue a land lease liability over 20 years at which time the amount of the land lease payments and interest accrued will approximate $107.4 million. In year 20, the SPE will have the following alternatives, and the chosen alternative must be communicated to Enterprise A during the 18^{th} year of the lease term:
   1. The SPE pays off the land lease liability by refinancing the building, begins making annual payments under the land lease for the remaining 45 years, and continues to lease the building to either the owner of the land or another tenant; or
   2. The SPE sells the building and pays off the land lease liability with the proceeds from the sale. The entity that purchases the building, purchases it subject to the existing underlying land lease in that the new building owner will be obligated to make land lease payments to Enterprise A for the remaining term and may have certain reasonable limitations as to the modifications of the property improvements that can be made on the underlying land (e.g., the color of the bricks used on any improvements to the building must be consistent with those used by the surrounding buildings).
The obligations of the SPE with respect to the land lease may be guaranteed on a full recourse basis by the Investor of the SPE. The SPE may require the investor to provide additional funding to the SPE if the value of the assets in the SPE (e.g., building, land lease position, and cash) are insufficient to pay the land lease liability owed to Enterprise A when it comes due.
If using the VIE embodiment, Enterprise A will transfer ownership of its land to the VIE. If using the bargain purchase option (“BPO”) embodiment, the BPO is preferably incorporated in the land lease.
   Enterprise A (“Lessee”) Accounting for Example PFG Transaction

The PFG transaction described above qualifies for sale-leaseback accounting by Enterprise A. In a transaction that qualifies for sale-leaseback accounting, the seller-lessee records the sale; removes all property and related liabilities from its balance sheet; recognizes gain or loss from the sale in accordance with FASB Statement No. 13, Accounting for Leases (“SFAS 13”) as amended by FASB Statement No. 28, Accounting for Sales with Leasebacks (“SFAS 28”), FASB Statement No. 66, Accounting for Sales of Real Estate (“SFAS 66”) and FASB Statement No. 98, Accounting for Leases: Sale-leaseback Transactions Involving Real Estate, Sales-Type Leases of Real Estate, Definition of the Lease Term, and Initial Direct Costs of Direct Financing Leases (“SFAS 98”); and classifies the leaseback in accordance with SFAS 13, as amended by SFAS 28.

In accordance with SFAS 98, a seller-lessee should use sale-leaseback accounting only if a sale-leaseback transaction involving real estate includes all of the following:
1. A “normal leaseback.”
2. Payment terms and provisions that adequately demonstrate the buyer-lessor's initial and continuing investment in the property acquired. (SFAS 66 defines initial and continuing investment in paragraphs 8-16).
3. Payment terms and provisions that transfer all of the other risks and rewards of ownership as demonstrated by the absence of any continuing involvement by the seller-lessee other than a normal leaseback.

A “normal leaseback” is defined in SFAS 98 as a lessee-lessor relationship that involves the active use of the property by the seller-lessee in consideration for rental payments, including contingent rents that are based on future operations of the seller-lessee, and excludes other continuing involvement provisions that are discussed below. The building leased back by Enterprise A must be used during the lease term in its trade or business, and any subleasing of the building must be “minor.” Otherwise, the sale and lease do not qualify as a sale-leaseback. The description of the transaction indicates a “normal leaseback” in which Enterprise A will not sublease any portion of the building that may result in the present value of the sublease rental payments being greater than 10 percent of the fair value of the building at the date of sale. Accordingly, any subleasing activity will be considered “minor” and will satisfy criterion 1 above.

The transaction would be accounted for as a sale-leaseback transaction in the following manner as prescribed in Example 1 in Appendix A of SFAS 98:
A sale is recorded and the property and any related debt is removed from Enterprise A's balance sheet.
Compute any gain that would be recognized, absent the leaseback, using the guidance in paragraph 39 of SFAS 66. Any loss on sale would be recognized at the date of sale.
Determine whether the leaseback qualifies as a capital lease or an operating lease under the provisions of SFAS 13. As discussed herein, it is assumed that the building leaseback is classified as an operating lease.
Defer the gain and do not commence amortization of the gain until the land lease payments are made, which is assumed to be in year 20.

The leaseback of the building by Enterprise A is classified as either a capital lease or an operating lease in accordance with SFAS 13. If the lease meets one of the following four criteria of paragraph 7 in SFAS 13, the lease should be classified as a capital lease:
1. The lease transfers ownership of the property to the lessee by the end of the lease term.
2. The lease contains a bargain purchase option.
3. The lease term is equal to 75 percent or more of the estimated economic life of the leased property.
4. The present value at the beginning of the lease term of the minimum lease payments, excluding that portion of the payments representing executory costs paid by the lessor, equals or exceeds 90 percent of the excess of the fair value of the leased property.

In this exemplary transaction, the leaseback of the building will not meet any of the four criteria described above for treatment as a capital lease and, therefore, the leaseback will be accounted for as an operating lease. In accordance with paragraph 15 of SFAS 13, Enterprise A should recognize the total rental payments due over the 20 year lease term ($156 million) as an expense on a straight-line basis.

Paragraph 26 of SFAS 13, which provides guidance on the application of the lease classification tests for leases involving land and building, does not specifically address sale-leaseback transactions of real estate where the underlying land is retained by the seller-lessee. However, in applying SFAS 13, it is appropriate for Enterprise A to analyze the leaseback of the building and sublease of the land as separate lease transactions in applying the lease classification tests, rather than as a single unit.

Enterprise A should recognize rental income on the land lease on a straight-line basis, over the lease term in accordance with paragraph 19(b) of SFAS 13. Enterprise A should also recognize interest income, relating to any land lease payments deferred by the SPE, as it accrues based on the market interest rate Enterprise A charges. In addition, the guidance provided in SEC Staff Accounting Bulletin No. 101, Revenue Recognition in Financial Statements (“SAB 101”), should also be considered by SEC reporting entities for this transaction, because the payment terms under the land lease allow the SPE to defer making land lease payments for 20 years.

The future minimum rental payments required as of the date of the latest balance sheet presented, in the aggregate and for each of the five succeeding years, should be disclosed in Enterprise A's financial statements. In addition to the other disclosure requirements of SFAS 13 and SFAS 66, the financial statements of Enterprise A should include a description of the terms of the sale-leaseback transaction and the land lease arrangement, including future commitments and/or obligations. The methodologies used to recognize revenue should be disclosed in Enterprise A's revenue recognition policy. In addition, in accordance with SAB 101 as discussed herein, the extended payment terms on the land lease should be disclosed.

The above detailed, sample PFG transaction is not meant to limit the invention to the specific accounting details or rules described therein (which may change), except as required to realize related aspects of the invention if desired (e.g., including achieving operating lease treatment for the lessee).

Lessor Accounting

The key to understanding the application of FASB 13, “Accounting for Leases,” is to look at the lease transaction from the perspective of each party. From a lessee's point of view, when the benefits and burdens of ownership of the property leased lie with the lessor, then the lease is an operating lease. In that event the lessee will not be required to record the property and its related liabilities on its balance sheet. By and large, this is the preferred treatment for a lessee and PFG/CPFG transactions are generally structured to meet this end. From the lessor's perspective, if the benefits and burdens of ownership are transferred to the lessee, then the lessor will record the lease as either a sales-type lease or a direct financing lease. This is the optimal situation from the lessor's perspective and PFG/CPFG transactions may be structured to accomplish this goal. Obviously, as evidenced above, the parties to every lease have divergent views of the preferred treatment for the lease. Fortunately, FASB 13 allows for both goals to be met.

While a lessee will classify a lease as an operating lease or a capital lease, a lessor will classify a lease as a sales-type, direct financing, leveraged, or operating lease depending upon the facts and circumstances of the particular transaction. A leveraged lease is a form of a direct financing lease. If a lease is classified as a direct financing lease and involves at least three parties, i.e., a lessee, a long-term creditor, and a lessor, with the financing provided by the long-term creditor being non-recourse to the general credit of the lessor, and the lessor's net investment declines and increases before it finally dissolves, then the lease will be termed a leveraged lease.

The concept underlying the accounting for leases by lessors as set forth in FASB 13 is that a lease that transfers to the lessee “substantially all of the benefits and risks incident to the ownership of property should be accounted for as a sale or financing by the lessor.” In other words, if the lessee obtains ownership of the property through the terms of the lease or the lessee effectively pays for the entire property through its lease payments, then the lessor is actually selling or financing the property. Thus, the benefits and burdens of ownership lie with the lessee. The economic effect on the parties in a lease that transfers the benefits and risks of ownership is similar, in many respects, to that of an installment purchase. Consequently, the lessor will account for such a lease as either a sales-type lease or a direct financing lease; all other leases will be accounted for as operating leases.

The question of what constitutes “substantially all of the benefits and risks incident to ownership” is governed by four classification criteria found within FASB 13. The same four classification criteria which were considered by the lessee in determining whether the lease is an operating lease or a capital lease are applied to the lessor to determine whether a lease transfers all of the benefits and burdens of ownership, namely:
a. The lease transfers ownership of the property to the lessee by the end of the lease term.
b. The lease includes an option to purchase the leased property at a bargain price.
c. The lease term is equal to or greater than 75 percent of the estimated economic life of the leased property.
d. The present value of rental and other minimum lease payments equals or exceeds 90 percent of the fair value of the leased property less any investment tax credit retained by the lessor.
   In addition, in the case of the lessor, if one (or more) of these criteria is met, the collectibility of the minimum lease payments is reasonably predictable and there are few (or no) important uncertainties surrounding the amount of unreimbursable costs yet to be incurred by the lessor under the lease, then the lease is classified as a sales-type lease, a direct financing lease, or a leveraged lease to the lessor.

Obviously, the first three criteria require both parties to treat the lease similarly. For example, if a lease transfers ownership of the leased property at the end of the lease term, then this criterion's result is the same for both parties. Thus, the first three criteria allow one party to the lease to receive the accounting treatment it desires but not the other party.

Because of the way in which the fourth classification criterion is calculated, divergent treatment and lease accounting by the parties is possible thereby providing the optimal result for each. In certain circumstances, this criterion may allow the lessee to treat a lease as an operating lease while the lessor treats the same lease as a sales-type lease, a direct financing lease, or a leveraged lease. In other words, from the point of view of the lessee the risks and benefits of ownership lie with the lessor but from the point of view of the lessor the same risks and benefits lie with the lessee. This result permits the goals of both parties to the lease to be achieved. Although this appears intuitively impossible, the fourth criterion permits such treatment as discussed below.

The fourth criterion, also known as the “90% Recovery Test,” compares the present value of the minimum required payments under the lease with the property's value to determine whether the risks and benefits of ownership have been transferred. Specifically, a lease is not an operating lease to the lessor if the “present value at the beginning of the lease term of the minimum lease payments . . . equals or exceeds 90 percent of the . . . fair value of the leased property to the lessor at the inception of the lease.” The present value of the minimum required payments is likely to vary depending on whether it is viewed on behalf of the lessee or the lessor. The lessor computes the present value of the minimum lease payments using the interest rate implicit in the lease while the lessee generally uses its cost of funds in determining the present value of the minimum lease payments. Therefore, the disparate treatment is possible if the lessee's cost of funds is greater than the interest rate implicit in the lease as calculated by the lessor.

The lessor's implicit interest rate is defined as “the discount rate that, when applied to (a) the minimum lease payments . . . and (b) the unguaranteed residual value accruing to the benefit of the lessor causes the aggregate present value at the beginning of the lease term to be equal to the fair value of the leased property to the lessor at the inception of the lease . . . .” FASB L10.412. Thus, the implicit rate is a function of the minimum lease payments, the fair value of the leased property to the lessor at the inception of the lease, and the unguaranteed residual value of the leased property that benefits the lessor.

While the “minimum lease payments” are generally clearly established by the underlying lease, and the fair value of the property to the lessor at the inception of the lease is apparent in the transaction, the unguaranteed residual value of a leased property is a subjective valuation on the part of the lessor. It is noted that the valuation of the residual is dependent upon the facts and circumstances of the particular transaction but, most importantly, it is the estimated fair value of the leased property at the end of the lease term “accruing to the benefit of the lessor.” Thus, if the lessor is not entitled to any amount on disposition of the property, then no unguaranteed residual value would accrue to its benefit. FASB L10.412 fn 403. If the fourth criterion is met from the lessor's perspective, then the lease passes the benefits and burdens of ownership to the lessee and the lessor will classify the lease as either a sales-type lease or a direct financing lease. Leases that involve lessors that are primarily involved in financing operations, as is the case in all PFG/CPFG transactions, will be direct financing leases.

Once it is determined that a lease is a direct financing lease, the lease may be considered a leveraged lease provided it has all of the following characteristics:
a. It involves at least three parties: a lessee, a long-term creditor, an a lessor.
b. The financing provided by the long-term creditor is substantial to the transaction and is not recourse to the lessor.
c. The lessor's net investment declines during the early years and increases during the later years of the lease term.
d. Any investment tax credit retained by the lessor is accounted for as one of the cash flow components of the lease.
   Because of the favorable GAAP accounting treatment associated with a leveraged lease, a direct financing lease is often structured to meet the above characteristics.

As a leveraged lease, the lessor would record the investment net of the no recourse debt. Thus, the loan associated with the leased property is offset against the property's fair value and only the difference, e.g., the lessor's equity in the transaction, would be shown on the lessor's balance sheet. Additionally, from an income statement purpose, the total net income over the lease term is calculated by deducting the original investment from total cash receipts. By using projected cash receipts and disbursements, the rate of return on the net investment in the years in which the investment is positive is determined and applied to the net investment to determine the periodic income to be recognized. Income would be recognized only in periods in which the net investment net of related deferred taxes is positive. Thus, the lessor would be able to report positive earnings on its GAAP financial statements at the same time its tax returns indicate yearly losses. At the end of the lease term, the earnings reported for both tax and GAAP purposes will be the same; it is only the timing of those earnings that differs. L10 Summary, p.7.

In accordance with certain exemplary embodiments, the PFG/CPFG transactions are structured to provide operating treatment to the lessees and leverage lease treatment for the lessors. In one embodiment, the lessor achieves leverage lease treatment through the application of the fourth criteria, the 90% test. In other embodiments, the lessor achieves capital lease treatment on the land using a bargain purchase option or VIE. Since all PFG/CPFG transactions are, by their very nature, financings, the leases will be direct financing leases if operating lease treatment is avoided for the lessor. The fourth criterion should be applied from the lessor's perspective as follows.

The fourth criterion in a direct financing lease requires that, from the perspective of the lessor, the present value of the minimum lease payments equal or exceed 90% of the value of the leased property. It is necessary to determine the implicit interest rate in a lease to calculate the present value of the lease payments. Of the three variables included in the determination of the interest rate implicit in the lease, two of them are clearly established in a PFG/CPFG transaction, namely the “minimum lease payments” and the fair value of the property to the lessor at the inception of the lease. Because of the unique nature of the ground rent accrual in a PFG/CPFG transaction, the third component, the unguaranteed residual value of a leased property, is the difference between the projected value of the building and the offsetting ground accrual liability. As expressly noted in the definition of the interest rate implicit in the lease, it may include “factors which a lessor might recognize in determining his rate of return.” FASB L10.412. In a PFG/CPFG transaction, the ground accrual is an element in the determination of the lessor's rate of return in its investment and should be considered in the valuation of the residual value.

Because the lessor's investment in the building is substantially diminished by its obligation to pay the associated land lease accrual, the unguaranteed residual value must be reduced by the accrual. In all PFG/CPFG transactions an appraisal is done at the inception of the transaction which is the most reasoned assessment of the future valuation of the building based upon the facts and circumstances available at that time. The ground lease accrual is also firmly established by the lease. Thus, the unguaranteed residual value of the property accruing to the benefit of the lessor at the end of the lease should be the difference between the ground accrual and the projected valuation of the building. Since the ground accrual is set to be approximately eighty-five percent of the projected future value of the building, the unguaranteed residual value is fifteen percent of the projected future value of the building.

Under the most conservative of assumptions in a PFG/CPFG transaction, namely the “Walk-away Scenario,” it is assumed that the building appreciates at only eighty-five percent of the projected appreciation rate. Thus, the “value” accruing to the benefit of the lessor in such a scenario would be nothing since the lessor will simply exchange the building for the ground accrual liability. If the lessor is not entitled to any amount on disposition of the property, then no unguaranteed residual value would accrue to its benefit. FASB L10.412 fn 403. If, however, the asset appreciates to a value greater than eighty-five percent of the original appraisal's projected ending value, then the lessor will benefit by the difference of this amount and the ground accrual liability. Therefore, the unguaranteed residual value in any PFG/CPFG transaction should be set between nothing and fifteen percent of the future projected value.

From the perspective of the lessor, the fourth criterion is easily passed in all PFG/CPFG transactions when the unguaranteed residual value is set at fifteen percent of the future projected value. In other words, from the perspective of the lessor the minimum lease payments cover 90% or more of the fair value of the leased property. Since these transactions are “financings,” they are also classified as direct financing leases. Furthermore, because the transactions are structured to meet the leveraged lease criteria, the transactions qualify for leveraged lease treatment.

The rationale expressed above support leveraged lease treatment for lessors in PFG/CPFG transactions. Because of the impact of the ground accrual to the lessor's rate of return on the transaction, the ground accrual must be considered in determining the residual value of the transaction accruing to the benefit of the lessor. By netting the accrual against the projected future appraised value of the building, the lessor's residual value will be approximately fifteen percent of the future value of the building. Using this amount as the residual value in calculating the interest rate implicit in the lease, from the lessor's perspective the 90% Recovery Test is met. Thus, the lessor in PFG/CPFG transactions should be accorded leveraged lease treatment.

Computer Modeling Tool:

The above-referenced provisional application includes, as Attachments 3 and 5, respectively, printouts of computer spreadsheets used in connection with the PFG and CPFG models. These spreadsheets are used to analyze and qualify possible properties for use in accordance with certain exemplary embodiments. The spreadsheets define models that are used to simplify the optimization of the overall transactions for the parties involved. Copies of the main spreadsheet and the supporting spreadsheets are provided for both the PFG and CPFG models in the provisional application. For example, spreadsheets are provided which show three ways to calculate the IRR for two different possible scenarios for each model. The first scenario assumes that the investor will walk away from the property after the initial deferral period (e.g., 20 years). The second scenario assumes that the investor will keep the land and refinance the property. It is noted that some of the calculations for the IRR have been truncated due to the number of pages required to print the entire spreadsheet. However, the methodology used for these calculations can be seen from the pages provided and can easily be understood by one skilled in the art. All of the spreadsheets from the provisional application are incorporated herein by reference. However, the spreadsheets only provide a tool for simplifying the transaction structure and determining if the conditions described above are satisfied. This work can be done using any suitable spreadsheet or other computer application using known techniques and applying the teachings of the instant invention.

In order to provide a better understanding of the exemplary computer modeling tool used by the instant inventors, a further discussion of its purpose and operation is provided below.

The computer model is designed to qualify transactions and perform a balancing for all parties to the transaction. For example, the model attempts to achieve the advantageous accounting treatment described above. Specifically, the computer model runs numbers to determine if the transaction will pass the 4^{th} prong of FASB 13 for the lessee, thereby enabling the lessee to treat the lease as an operating lease. At the same time, the computer model runs numbers to determine if the transaction will pass the 4^{th} prong of FASB 13 for the lessor, thereby achieving leverage lease treatment for the lessor. Thus, the model assists in structuring a specific transaction so as to have the FASB 13, 4^{th} prong be less than 90% for the lessee and greater than 90% for the lessor. The model takes into account the time value of money and the present value of the asset involved, and determines, for example, what amount of rent will need to be charged to the lessee in order to pass FASB 13 and still achieve a desired return for the lessor. For example, if a target IRR for the transaction is 9½%, which may be the minimum required return for any investor in this transaction, that will require that the lessee pay a certain amount of cash in order to achieve that return. The computer model assists in structuring the transaction so as to make sure that that payment of cash does not violate the 90% test for the lessee.

As indicated above, the computer model helps balance the needs of the different parties to the transaction. From the lessee's perspective, operating lease treatment and the lowest possible rent is desired. Of course, the lower the rent, the less return that will be realized by the lessor. The computer model helps determine, using known mathematical and accounting techniques, the minimum acceptable level of return needed by the lessor, which then indicates the necessary rent to the lessee. In this regard, the computer model can be used to determine what the rent should be, taking into account the equity's tax position. That rent can then be compared to what would be achievable for the lessee if it went out to the marketplace and obtained a straight loan. Generally speaking, it has been found that the lessee saves between 30-50 basis points when using the transaction structures of the instant invention. In other words, by bringing in equity at low cash cost, that low cash cost equity can be mixed with achievable debt to achieve an overall cost of capital to the lessee that is, for example, 20 to 50 basis points less than what the lessee could achieve in the marketplace. In addition, if the lessee went to the marketplace and borrowed money at the market rates, it would treat the borrowing as a capital lease which would be on its books both as debt and equity. As explained above, the PFG and CPFG transaction structure of the invention enables operating lease treatment, thereby avoiding treatment on the balance sheet.

In connection with certain PFG transactions, the interests of two parties must be balanced—the lessee and the lessor. In some scenarios, the lessee is the original owner of both the land and the building. The lessor purchases the building and leases the land and subsequently leases both properties, the building and the land, back to the lessee. Thus, the computer model assists in balancing the interests of the lessee and the lessor in a PFG transaction. However, in cases where this relationship is not the case, it will be appreciated that the balancing may be performed differently.

In a CPFG transaction, the selling party is generally a tax-paying entity. The tax-paying entity sells both its land and its building and treats this transaction like a straight lease back of its property. In a CPFG transaction, the land is being purchased by a non-tax paying entity, such as a pension fund. The pension fund can absorb income in the form of the accrued amounts. The building is purchased by equity investors. Thus, in a CPFG transaction, the computer model helps to balance the interests of three parties—the tax-paying entity, the non-tax paying entity, and the equity investors. This balancing involves trying to achieve a suitable IRR for the equity investor, trying to achieve the lowest possible rent for the tax-paying entity and trying to achieve a suitable IRR for the non-taxpaying entity. In both the PFG and CPFG embodiments which utilize zero-coupon subordinate debt in place of a ground lease, the same three-party balancing may be performed.

The non-taxpaying entity IRR in a CPFG ground lease, as well as in the PFG/CPFG zero-coupon bond structure, is achieved by the non-taxpaying entity purchasing the land or zero-coupon bond today for a certain amount of money. The non-taxpaying entity does not receive any cash during the deferral term of the lease or until maturity of the bond (e.g., 20 years). At the end of the deferral term, the non-taxpaying entity receives the amount of the accrual on the ground rent or due under the bond, for example, and that accrual will result in a return to the non-taxpaying entity (e.g., 10%). Thus, the computer model balances a desired return for the non-taxpaying entity, a desired return for the equity investor, and a desired rent payment (or cap rate) from the tenant, while also assuring that the desired lease treatment is achieved for the parties under FASB 13.

The above-described structuring and balancing can be done using any suitable method and does not require use of any specific tool. The analysis, structuring and balancing for the transaction is done using known mathematical and accounting techniques, as one skilled in the art will understand from the description of the invention herein. Thus, further details of the computer model are not provided herein in order to avoid obscuring the invention with unnecessary details of an exemplary computer tool. However, detailed spreadsheets from the exemplary computer tool are provided in the above-referenced provisional application, incorporated herein by reference.

PFG and CPFG General Transaction Steps

The following description provides a basic overview of the main steps taken to assemble the parties and necessary elements for a PFG or CPFG transaction, in accordance with an exemplary embodiment.

The first step is for a transaction service provider to market a proposed transaction to potential clients interested in restructuring their real estate holdings (tax-indifferent parties in the case of PFG transactions; taxpaying entities in the case of CPFG transactions). This generally involves: explaining separation of ownership of land and building under the PFG/CPFG model; explaining the ground rent or zero-coupon subordinate debt accrual feature under the PFG/CPFG model; explaining the rights and obligations of all parties to the transaction throughout the life of the transaction; explaining the exit strategies; explaining the benefits of following the model; and explaining the accounting and tax treatments under the model.

If a potential client is interested in the transaction, the next step involves producing a pro forma financial structure under the model for the client's particular real estate project. If a potential client wishes to proceed, the next step involves refining the structure based on additional information from the potential client concerning its current real estate values and goals for a possible transaction.

The next step involves determining whether there is interest by the potential client, potential investors, potential lenders, and, if a CPFG or zero-coupon subordinate bond transaction, potential tax-indifferent parties interested in long term investment. If sufficient interest is shown by the above parties, the next step is to prepare a Plan of Finance for the contemplated transaction to present to the potential client. If the client accepts the Plan of Finance, the transaction service provider then seeks to secure investors, lenders, and, if needed, tax-indifferent parties to participate in the transaction.

Finally, steps are then taken to close the transaction. This includes preparing the following documents to implement the transaction: a sales agreement for, and deed to, the land in the PFG VIE model or the CPFG model; a ground lease or zero-coupon subordinate debt documents; a space lease; limited partnership or limited liability company agreement to organize the SPE; to the extent requested, amortizing loan documents for a development loan to help finance the transaction; a private placement memorandum if necessary to select the potential investors and investor subscription documents; and standard real estate closing documents. Tax and/or accounting opinions are then obtained if requested. An appraisal of the property is obtained. Title to the property is searched and cleared, as needed. A property survey is obtained. Any necessary environmental remediation is done or arranged for. Any necessary steps are taken to obtain applicable tax credits. In construction or renovation transactions, a guaranteed maximum price (gmp) construction contract and architect's agreement is negotiated. The necessary insurance coverage is arranged. Other additional actions are taken as needed or desired.

As explained in detail above, certain exemplary embodiments provide significant advantages as compared to prior real estate financing methods. For example, from the lessee's perspective, the transactions may be structured so that they achieve operating lease treatment, thereby avoiding adverse impact to the lessee's balance sheet. At the same time, from the lessor's perspective, the transactions may be structured to achieve leverage lease accounting treatment, thereby removing the real estate and its associated liabilities from the lessor's balance sheet and enhancing its credit ratings. This advantageous accounting treatment is achieved through accrual of the ground rent either alone or in combination with other tangible or intangible assets. In accordance with certain exemplary embodiments, the accrual enables leverage lease treatment to be achieved for the lessor in both PFG and CPFG transactions.

In a PFG transaction, the netting of the ground rent versus the building rent enables operating lease treatment by the lessee under FASB 13. In a CPFG transaction, the accrual is also instrumental in achieving operating lease treatment for the lessee by allowing lower rent payments. Thus, certain exemplary embodiments provide novel methods of using an accrual to achieve the desired accounting treatment for all parties to a real estate transaction.

Exemplary Transaction Implementation

The exemplary embodiments described herein have been implemented successfully in at least one illustrative transaction. Of course, it will be appreciated that the structure of this illustrative transaction is given by way of example and without limitation. Briefly, the terms and conditions of the transaction are as follows.
1) Purchase of Real Estate
The equity investor(s) (the “Equity Investor”) purchased an equity interest(s) in the Investment LLC, which owns the project known as the United States Patent and Trademark Office Headquarters Facility, consisting of buildings and parking garages containing approximately 2,464,000 square feet, located in Alexandria, Va. (the “Headquarters Facility” or the “Project”). The Equity Investor paid for the interests it purchased in cash and shall receive associated benefits in the form of depreciation and interest deductions from the Headquarters Facility, and amortization deductions from the transaction costs as well as the value of its equity when realized. At closing, the Project was encumbered by the acquisition indebtedness, the Senior Subordinate Bonds and the Junior Subordinate Bonds, all as described below.
2) Accruing Loan (Senior Subordinate Bonds)
The Investment LLC sold Senior Subordinate Bonds secured by the Headquarters Facility, which are junior to the interests of the existing senior bonds which financed the original acquisition of the land and construction of the improvements (“Senior Bonds”) but senior to the interests of the holders of the Junior Subordinate Bonds, as defined below. The Senior Subordinate Bonds will mature on Sep. 15, 2032 immediately following retirement of the Senior Bonds. Should the Investment LLC not make the required payment at that time, the holders of the Senior Subordinate Bonds can foreclose on and sell the Headquarters Facility, redeem the Senior Subordinate Bonds and deliver the remaining sale proceeds, if any, to the holders of the Junior Subordinate Bonds.
3) Accruing Loan (Junior Subordinate Bonds)
The Investment LLC has also sold Junior Subordinate Bonds secured by the Headquarters Facility, which are junior to the interests of the Senior Bonds and to the interests of the holders of the Senior Subordinate Bonds. The Junior Subordinate Bonds will mature on Sep. 15, 2032 immediately following retirement of the Senior Bonds and simultaneously with the Senior Subordinate Bonds. Should the Investment LLC not make the required payment at that time, the holders of the Junior Subordinate Bonds can foreclose on and sell the Headquarters Facility, repay any amounts due the holders of the Senior Subordinate Bonds, redeem the Junior Subordinate Bonds and deliver the remaining sale proceeds, if any, to the Investment LLC. If the Junior Subordinate Bonds are paid at maturity they will generate an overall IRR of 12.60% on a semi-annual, compounding basis, exclusive of participation rights.

The Headquarters Facility is currently leased to the United States General Service Administration (the “GSA”) and the United States Patent and Trademark Office (the “USPTO”) with the USPTO as the sole occupant under both leases. The rent obligations under the leases are general, full faith and credit obligations of the United States. The Project consists of five interconnected main office buildings, two townhouse style office buildings and two parking garages.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of funding real estate controlled by a first party, wherein the real estate includes land with at least one existing building or at least one building desired to be constructed or renovated thereon, the method comprising:
constructing or renovating the at least one building, if necessary;
selling the land to a tax-indifferent party;
leasing the land to the first party using a land lease, the land lease having a set term and providing the option to defer and accrue land rent obligations for a predefined initial period;
leasing the at least one building to a tenant; and,
subleasing the land to the tenant.

2. The method of claim 1, wherein the first party is a building owner.

3. The method of claim 1, wherein the first party is a developer.

4. The method of claim 1, further comprising seeking debt and equity investment directly for use by the first party.

5. The method of claim 1, further comprising seeking the debt and equity investment via a second entity, the second entity being suitable to own the at least one building and lease the land on behalf of the first party.

6. The method of claim 5, wherein the second entity is organized as either a partnership or as a limited liability company.

7. The method of claim 1 wherein the land is transferred to a variable interest entity or the land lease contains a bargain purchase option.

8. The method of claim 1, further comprising executing the building lease prior to the land leaseback, the land sale and land lease being subject to the building lease.

9. The method of claim 1, wherein the tax-indifferent party is the original land owner that sells any already existing at least one building to the first or second party and leases the at least one building and subleases the land.

10. A method of funding real estate owned by a first party, wherein the real estate includes land with at least one building desired to be constructed or renovated thereon, the method comprising:
leasing the land and the at least one building to a tenant;
obtaining senior debt financing from at least one third-party lender, the at least one third-party lender being unrelated to the first party and the tenant; and,
obtaining subordinate debt from at least one tax-indifferent lender, the subordinate debt being obtained via at least one tranche and being structured to accrue as a zero-coupon due no sooner than upon senior debt amortization.

11. The method of claim 10, wherein the land lease is structured to terminate no sooner than upon senior debt amortization.

12. The method of claim 10, wherein the at least one third-party lender is an institutional lender.

13. The method of claim 10, wherein the senior debt is guaranteed to have a first place security position against the property.

14. The method of claim 10, wherein the subordinate debt is structured to be non-recourse to the first party.

15. The method of claim 10, further comprising insuring at least a part of the subordinate debt with residual value insurance to insure a land value suitable for providing a fixed yield to an insured subordinate lender.

16. The method of claim 10, wherein the land lease is structured as a leveraged lease for the property owner and an operating lease for the tenant.

17. The method of claim 10, further comprising obtaining equity investment for the first party.

18. The method of claim 17, further comprising obtaining equity investment for the first party via an entity suitable to own the land and lease the at least one building on behalf of the first party.

19. The method of claim 18, wherein the entity is organized as either a partnership or as a limited liability company.

20. The method of claim 10, further comprising:
allowing the first party to optionally seek leveraged lease treatment under the land lease; and,
allowing the tenant to optionally seek operating lease treatment under the land lease.
